(19) United States
(12) Patent Application Publication
(10) Pub. No.: US 2026/0333053 A1
(43) Pub. Date: Oct. 22, 2026

(54) EXTENSIBLE USER CHALLENGE FOR ESIM DOWNLOAD AND WIRELESS DEVICE CHANGE

(71) Applicant: Apple Inc., Cupertino, CA (US)

(72) Inventors: Jean-Marc PADOVA, San Francisco, CA (US); Hyewon LEE, Cupertino, CA (US); Raj S. CHAUGULE, Santa Clara, CA (US)

(21) Appl. No.: 19/545,497

(22) Filed: Feb. 20, 2026

Related U.S. Application Data
(60) Provisional application No. 63/789,878, filed on Apr. 16, 2025.

(51) Int. Cl. H04W 12/30; H04W 8/20; H04W 12/06

(52) U.S. Cl. CPC H04W 12/35; H04W 8/205; H04W 12/06

(57) ABSTRACT

The described embodiments relate to wireless communications, including methods and apparatus for implementing an extensible user authentication and/or verification challenge during a cellular wireless service procedure for a wireless device, such as an electronic subscriber identity module (eSIM) download and installation to the wireless device or transfer of a cellular wireless service from the wireless device to another wireless device. A mobile network operator (MNO) provisioning server can prompt for required user-specific data to verify authority to perform the cellular wireless service procedure, where an MNO backend system can indicate via a standardized interface the required user-specific data and subsequently verify user data values supplied by the wireless device before allowing performance of the cellular wireless service procedure.

### CROSS-REFERENCE TO RELATED APPLICATIONS

The present application claims the benefit of U.S. Provisional Application No. 63/789,878, entitled “EXTENSIBLE USER CHALLENGE FOR ESIM DOWNLOAD AND WIRELESS DEVICE CHANGE,” filed Apr. 16, 2025, the content of which is incorporated by reference herein in its entirety for all purposes.

### FIELD

The described embodiments relate to wireless communications, including methods and apparatus for implementing an extensible user authentication and/or verification challenge during a cellular wireless service procedure for a wireless device, such as an electronic subscriber identity module (eSIM) download and installation to the wireless device or transfer of a cellular wireless service from the wireless device to another wireless device.

### BACKGROUND

Newer generation, fifth generation (5G), cellular wireless networks that implement one or more 3^{rd} Generation Partnership Project (3GPP) standards are rapidly being developed and deployed by mobile network operators (MNOs) worldwide. In addition, sixth generation (6G) standards are in active development. The newer cellular wireless networks provide a range of packet-based services, with 5G (and 6G) technology providing increased data throughput and lower latency connections that promise enhanced mobile broadband services for 5G-capable (and 6G-capable) wireless devices. Access to cellular services provided by an MNO can require use to cellular credentials and/or secure processing provided by a secure element (SE), such as a universal integrated circuit card (UICC), an embedded UICC (eUICC), or an integrated UICC (iUICC) included in the wireless device.

Typically, wireless devices have been configured to use removable UICCs, that include at least a microprocessor and a read-only memory (ROM), where the ROM is configured to store an MNO profile, also referred to as subscriber identity module (SIM) or SIM profile, which the wireless device can use to register and interact with an MNO to obtain wireless services via a cellular wireless network. The SIM profile hosts subscriber data, such as a digital identity and one or more cryptographic keys, to allow the wireless device to communicate with a cellular wireless network. Typically, a UICC takes the form of a small removable card, commonly referred to as a SIM card or physical SIM (pSIM) card, which can be inserted into a UICC-receiving bay of a mobile wireless device. In more recent implementations, UICCs are being embedded directly into system boards of wireless devices as eUICCs or integrated with other system components as iUICCs, which can provide advantages over traditional, removable UICCs. The eUICCs and/or iUICCs can include a rewritable memory that can facilitate installation, modification, and/or deletion of one or more electronic SIMs (eSIMs) on the eUICC/iUICC, where the eSIMs can provide for new and/or different services and/or updates for accessing extended features provided by MNOs. An eUICC/iUICC can store a number of MNO profiles—also referred to herein as eSIMs—and can eliminate the need to include UICC-receiving bays in wireless devices. The use of multiple SIMs and/or eSIMs is expected to offer flexibility for access to multiple services of multiple wireless networks.

A wireless device can obtain an eSIM profile from an MNO provisioning server for access to a cellular wireless service of the MNO. Different MNO systems can require various user data to verify authority to provide the eSIM profile to the wireless device. Techniques are needed to implementing an extensible user authentication and/or verification challenge during a cellular wireless service procedure for a wireless device.

### SUMMARY

The described embodiments relate to wireless communications, including methods and apparatus for implementing an extensible user authentication and/or verification challenge during a cellular wireless service procedure for a wireless device, such as an electronic subscriber identity module (eSIM) download and installation to the wireless device or transfer of a cellular wireless service from the wireless device to another wireless device. A mobile network operator (MNO) provisioning server can prompt for required user-specific data to verify authority to perform the cellular wireless service procedure, where an MNO backend system can indicate via a standardized interface the required user-specific data and subsequently verify user data values supplied by the wireless device before allowing performance of the cellular wireless service procedure. In some embodiments, after mutual authentication between the MNO provisioning server and the wireless device and before initiation and/or continuation of a cellular wireless service procedure for the wireless device, the MNO provisioning server requires the wireless device to obtain data values to verify authority to perform the cellular wireless service procedure. In some embodiments, a user challenge message from the MNO provisioning server to the wireless device includes one or more configurable fields for each data value required for user verification, such as a description field, a type mask, a data type, a flag indicating whether hashing of data is required, and/or an error type mask. The type mask provides a standardized indication of a type of data value required, where the wireless device can present a localized, user friendly and/or device specific description of the required data based on the type mask value. In some embodiments, a third-party maintains a logical list of type mask values corresponding to different data types. In some embodiments, a device original equipment manufacturer (OEM) defines a mapping between type mask values and localized, user friendly descriptions for the required user data. Exemplary data types include user name, password, electronic address, plain text, an image file, a quick response (QR) code scan, a file or document type, a universal resource locator (URL). In some embodiments, one or more user data values are required to be hashed before communicated to the MNO provisioning server. In some embodiments, the MNO backend system verifies one or more hashed user data values to verify authority to perform the cellular wireless service procedure. In some embodiments, the MNO backend system provides an indication of one or more errors by specifying one or more type masks for data values required to be resubmitted for verification prior to allowing the cellular wireless service procedure to be performed.

Other aspects and advantages of the invention will become apparent from the following detailed description taken in conjunction with the accompanying drawings which illustrate, by way of example, the principles of the described embodiments.

This Summary is provided merely for purposes of summarizing some example embodiments so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The disclosure will be readily understood by the following detailed description in conjunction with the accompanying drawings, wherein like reference numerals designate like structural elements.

FIG. 1 illustrates a block diagram of different components of an exemplary system configured to adapt communication parameters for a wireless device, according to some embodiments.

FIG. 2 illustrates a block diagram of a more detailed view of exemplary components of a wireless device of the system of FIG. 1, according to some embodiments.

FIG. 3 illustrates a block diagram of an exemplary system for remote profile management (RPM) of electronic subscriber identity module (eSIM) profiles of a wireless device, according to some embodiments.

FIGS. 4A and 4B illustrate flow diagrams of an example of an extensible user challenge for user verification based on user identification (ID) password values for an eSIM download procedure, according to some embodiments.

FIGS. 4C and 4D illustrate flow diagrams of another example of an extensible user challenge for user verification based on user identification (ID) password values with localization by the wireless device for an eSIM download procedure, according to some embodiments.

FIGS. 4E, 4F, and 4G illustrate flow diagrams of a further example of an extensible user challenge for user verification based on user identification (ID) password values with localization by the wireless device for an eSIM download procedure with error recovery, according to some embodiments.

FIGS. 5A and 5B illustrate flow diagrams of an example of an extensible user challenge for user verification based on user last name and billing zip code values for an eSIM download procedure, according to some embodiments.

FIGS. 6A and 6B illustrate flow diagrams of an example of an extensible user challenge for user verification based on a scan of a user-specific quick response (QR) code for an eSIM download procedure, according to some embodiments.

FIGS. 7A and 7B illustrates flow diagrams of an example of an extensible user challenge for user verification based on a live identification (ID) check for an eSIM download procedure, according to some embodiments.

FIG. 8 illustrates a flow diagram of an example of obtaining data for a new user subscription to a cellular wireless service via scan of a generic activation QR code that redirects a wireless device to a sign-up website, according to some embodiments.

FIGS. 9A and 9B illustrate flow diagrams of an example of an extensible user challenge for user verification based on user name and password values for transfer of a cellular wireless service between wireless devices without re-use of an existing eSIM profile, according to some embodiments.

FIGS. 10A and 10B illustrate flow diagrams of an example of an extensible user challenge for user verification based on user name and password values for transfer of a cellular wireless service between wireless devices with re-use of an existing eSIM profile, according to some embodiments.

FIG. 11 illustrates a flow chart of an exemplary method to provide an extensible user challenge to verify user authority to perform a cellular wireless service procedure for a wireless device, the method performed by one or more components of a provisioning server, according to some embodiments.

FIG. 12 illustrates a flow chart of an exemplary method to provide an extensible user challenge to verify user authority to perform a cellular wireless service procedure for a wireless device, the method performed by one or more components of the wireless device, according to some embodiments.

FIG. 13 illustrates a block diagram of exemplary elements of a wireless device, according to some embodiments.

### DETAILED DESCRIPTION

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

The described embodiments relate to wireless communications, including methods and apparatus for implementing an extensible user authentication and/or verification challenge during a cellular wireless service procedure for a wireless device, such as to initiate or continue a procedure for downloading and installing an electronic subscriber identity module (eSIM) to the wireless device or a procedure to transfer a cellular wireless service from the wireless device, e.g., as a source wireless device, to another wireless device, as a target wireless device. A mobile network operator (MNO) can require specific information from a wireless device (or a user thereof) to allow the cellular wireless service procedure to proceed. Different MNOs can require different types of information, and as described further herein, an extensible user challenge can permit the MNO to specify information required to verify that the wireless device (and/or the user thereof) has permission (authority) to perform a requested cellular wireless service procedure.

In some embodiments, an MNO backend system can communicate via a standardized interface, e.g., an ES2+ interface, with an MNO provisioning server to order provisioning of an eSIM for a wireless device. In some embodiments, an original equipment manufacturer (OEM) system may be involved in a cellular wireless procedure, e.g., for establishing a cellular service account, to order a wireless device, to request an eSIM for a wireless device, etc. In some embodiments, the OEM system can communicate with the MNO backend system and/or with the MNO provisioning server to assist with obtaining user information. In an exemplary embodiment, during a procedure to obtain an eSIM for a wireless device, after mutual authentication between an embedded universal integrated circuit card (eUICC) of the wireless device and an MNO provisioning server, e.g., as part of an SGP.22 eSIM download procedure, the MNO provisioning server can be required to provide a challenge to the wireless device (and/or to the user thereof) to obtain information before proceeding the with eSIM download procedure to release the eSIM for download and installation on the eUICC of the wireless device. In another exemplary embodiments, during a procedure to transfer cellular wireless service from a source wireless device to a target wireless device, e.g., as part of a GSM TS.43 procedure, the source wireless device and/or the target wireless device can be required to provide information for authentication before a token is provided to allow transfer of the cellular wireless service subscription between the source wireless device and the target wireless device.

A mobile network operator (MNO) provisioning server can prompt for required user-specific data to verify authority to perform the cellular wireless service procedure, where an MNO backend system can indicate via a standardized interface the required user-specific data and subsequently verify user data values supplied by the wireless device before allowing performance of the cellular wireless service procedure. In some embodiments, after mutual authentication between the MNO provisioning server and the wireless device and before initiation and/or continuation of a cellular wireless service procedure for the wireless device, the MNO provisioning server requires the wireless device to obtain data values to verify authority to perform the cellular wireless service procedure. In some embodiments, a user challenge message from the MNO provisioning server to the wireless device includes one or more configurable fields for each data value required for user verification, such as a description field, a type mask, a data type, a flag indicating whether hashing of data is required, and/or an error type mask. The type mask provides a standardized indication of a type of data value required, where the wireless device can present a localized, user friendly and/or device specific description of the required data based on the type mask value. As there is no standardized stet of data to verify a user or wireless device for a cellular wireless service procedure, different MNOs can require different data and can use different labels and have different explanatory text to include when obtaining data from a user/wireless device for authentication and verification. An extensible data dictionary can support various data types using an extendible structure to include various fields and accommodate different data formats. An MNO can determine different data fields to be required for a specific cellular wireless service task, e.g., an eSIM download. In some embodiments, a standardized framework for different possible options to gather data to verify/authenticate a wireless device and/or user thereof can be customized by an MNO by selecting different data fields to include in a challenge presented to the wireless device. In some embodiments, an MNO can require particular information to satisfy a “know your customer” (KYC) requirement, which can be region and/or country dependent, and the extensible user challenge provides a mechanism to gather such required information. A wireless device user interface can present proper controls to gather data formatted properly for the MNO and with localization to be understandable for the user of the wireless device. By standardizing information gathering with MNO customizability, cellular wireless services can be provided to a broad array of wireless devices from various MNOs without requiring customized solutions for each MNO and each wireless device OEM.

In some embodiments, a third-party maintains a logical list of type mask values corresponding to different data types. In some embodiments, a device original equipment manufacturer (OEM) defines a mapping between type mask values and localized, user friendly descriptions for the required user data. Exemplary data types include user name, password, electronic address, plain text, an image file, a quick response (QR) code scan, a file or document type, a universal resource locator (URL). In some embodiments, one or more user data values are required to be hashed before communicated to the MNO provisioning server. In some embodiments, the MNO backend system verifies one or more hashed user data values to verify authority to perform the cellular wireless service procedure. In some embodiments, the MNO backend system provides an indication of one or more errors by specifying one or more type masks for data values required to be resubmitted for verification prior to allowing the cellular wireless service procedure to be performed.

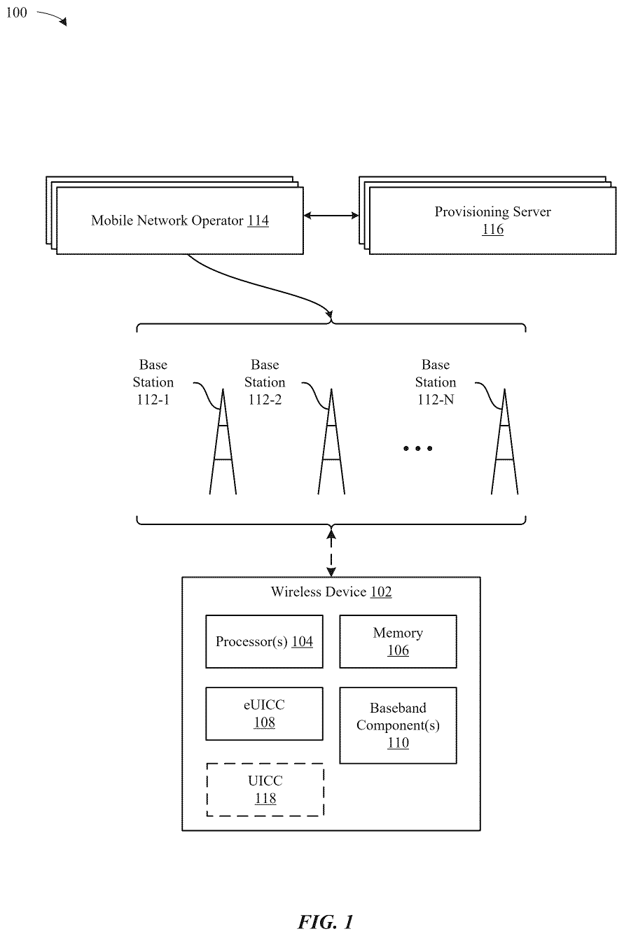

These and other embodiments are discussed below with reference to FIGS. 1 through 13; however, those skilled in the art will readily appreciate that the detailed description given herein with respect to these figures is for explanatory purposes only and should not be construed as limiting.

FIG. 1 illustrates a block diagram of different components of a system 100 that includes i) a wireless device 102, which can also be referred to as a mobile wireless device, a cellular wireless device, a wireless communication device, a mobile device, a user equipment (UE), a device, a primary wireless device, a secondary wireless device, an accessory wireless device, a cellular-capable wearable device, and the like, ii) a group of base stations 112-1 to 112-N, which are managed by different Mobile Network Operators (MNOs) 114, and iii) a set of provisioning servers 116 that are in communication with the MNOs 114. The wireless device 102 can represent a mobile computing device (e.g., a phone, a tablet, a peripheral device, etc.), the base stations 112-1 to 112-N can represent cellular radio access network (RAN) entities including fourth generation (4G) Long Term Evolution (LTE) evolved NodeBs (eNodeBs or eNBs), fifth generation (5G) NodeBs (gNodeBs or gNBs), and/or sixth generation (6G) NodeBs that are configured to communicate with the wireless device 102. Each of the base stations 112-1 to 112-n can be a single entity, quasi-collocated entities, or separated among multiple units (e.g., Central Units (CUs), Distributed Units (DUs), Remote Units (RUs)). The MNOs 114 can represent different wireless service providers that provide specific services (e.g., voice, data, video, messaging) to which a user of the wireless device 102 can subscribe to access the services via the wireless device 102. Applications resident on the wireless device 102 can advantageously access services of a cellular wireless network provided by a wireless service provider using 4G LTE connections, 5G connections, and/or 6G connections (when available) via one or more base stations 112.

As shown in FIG. 1, the wireless device 102 can include processing circuitry, which can include one or more processors 104 and a memory 106, an embedded Universal Integrated Circuit Card (eUICC) 108, and/or integrated UICC (iUICC) (not shown) and baseband component 110 used for transmission and reception of cellular wireless radio frequency signals. In some embodiments, the wireless device 102 can include one or more universal integrated circuit cards (UICCs) 118, also referred to as physical SIM cards, each UICC 118 including a SIM, in addition to or in place of the eUICC 108 providing one or more electronic SIMs (eSIMs) and/or an iUICC providing one or more eSIMs. A wireless device 102 that includes multiple active (enabled) SIMs and/or eSIMs can be referred to generally herein as a multi-SIM/eSIM wireless device. The one or more processors 104 can include one or more wireless processors, such as a cellular baseband component, a wireless local area network processor, a wireless personal area network processor, a near-field communication processor, and one or more system-level application processors. The components of the wireless device 102 work together to enable the wireless device 102 to provide useful features to a user of the wireless device 102, such as cellular wireless network access, non-cellular wireless network access, localized computing, location-based services, and Internet connectivity. Although depicted as distinct blocks, the various components (e.g., memory 106, processor(s) 104, eUICC 108, baseband component 110, and UICC 118) can be arranged and combined in any number of configurations.

The eUICC 108 can be configured to store multiple eSIMs for accessing services offered by one or more different MNOs 114 via communication through base stations 112-1 to 112-N. To be able to access services provided by the MNOs, one or more eSIMs can be provisioned to the eUICC 108 of the wireless device 102. The wireless device 102 can include wireless circuitry, including the baseband component 110 and at least one transmitter/receiver, also referred to as a transceiver to transmit to and receive cellular wireless signals from network access network entities of a cellular wireless network. In some embodiments, the provisioning server 116 can provide an indication to the wireless device 102 via a discovery service server of availability of an eSIM to download to the wireless device 102 or of a remote profile management (RPM) update for an eSIM resident of the eUICC 108 of the wireless device 102. In some embodiments, the wireless device 102 can initiate a procedure to download an eSIM from a provisioning server 116, and an MNO 114 associated with the provisioning server 116 can require additional information for verification and/or authentication of the wireless device 102 (or a user thereof) to obtain the eSIM. As described herein an extensible user authentication and/or verification challenge can be configured by an MNO backend system to require the provisioning server 116 to obtain user-specific information to be verified by the MNO backend system (and/or by the provisioning server 116) before allowing an eSIM download and installation procedure to occur.

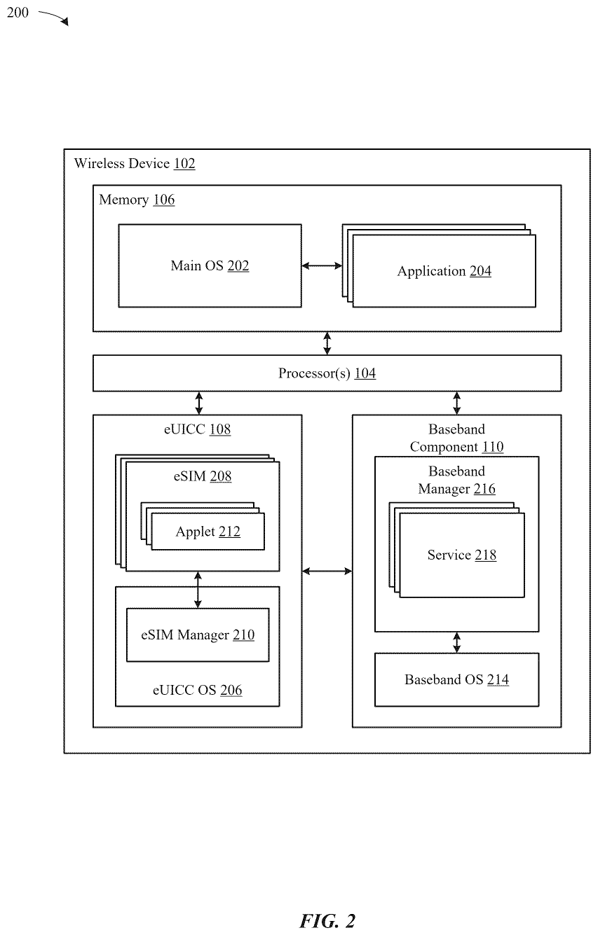

FIG. 2 illustrates a block diagram 200 of a more detailed view of exemplary components of a wireless device 102 of the system 100 of FIG. 1. The one or more processors 104, in conjunction with the memory 106, can implement a main operating system (OS) 202 that is configured to execute applications 204 (e.g., native OS applications and user applications). The one or more processors 104 can include applications processing circuitry and, in some embodiments, wireless communications control circuitry. The applications processing circuitry can monitor application requirements and usage to determine recommendations about communication connection properties, such as bandwidth and/or latency, and provide information to the communications control circuitry to determine suitable wireless connections for use by particular applications. The communications control circuitry can process information from the applications processing circuitry as well as from additional circuitry, such as the baseband component 110, and other sensors (not shown) to determine states of components of the wireless device 102, e.g., reduced power modes, as well as of the wireless device 102 as a whole, e.g., mobility states, activity/inactivity states. The wireless device 102 further includes an eUICC 108 that can be configured to implement an eUICC OS 206 to manage the hardware resources of the eUICC 108 (e.g., a processor and a memory embedded in the eUICC 108). The eUICC OS 206 can also be configured to manage eSIMs 208 that are stored by the eUICC 108, e.g., by enabling, disabling, modifying, updating, or otherwise performing management of the eSIMs 208 within the eUICC 108 and providing the baseband component 110 with access to the eSIMs 208 to provide access to wireless services for the wireless device 102. The eUICC OS 206 can include an eSIM manager 210, which can perform management functions for various eSIMs 208. Each eSIM 208 can include a number of applets 212 that define the manner in which the eSIM 208 operates. For example, one or more of the applets 212, when implemented by the baseband component 110 and the eUICC 108, can be configured to enable the wireless device 102 to communicate with an MNO 114 and provide useful features (e.g., phone calls and internet) to a user of the wireless device 102.

The baseband component 110 of the wireless device 102 can include a baseband OS 214 that is configured to manage hardware resources of the baseband component 110 (e.g., a processor, a memory, different radio components, etc.). The baseband component 110 (or a portion thereof) can also be referred to as a baseband component, a wireless baseband component, a baseband wireless processor, a cellular baseband component, a cellular component, and the like. According to some embodiments, the baseband component 110 can implement a baseband manager 216 that is configured to interface with the eUICC 108 to establish a secure channel with a provisioning server 116 and obtain information (such as eSIM data) from the provisioning server 116 for purposes of managing eSIMs 208. The baseband manager 216 can be configured to implement services 218, which represent a collection of software modules that are instantiated by way of the various applets 212 of enabled eSIMs 208 that are included in the eUICC 108. For example, services 218 can be configured to manage different connections between the wireless device 102 and MNOs 114 according to the different eSIMs 208 that are enabled within the eUICC 108. In some embodiments, a processor 104 of the wireless device 102 and/or the eUICC 108 can include a local profile assistance (LPA) module to assist with management of eSIMs on the eUICC 108 of the wireless device 102.

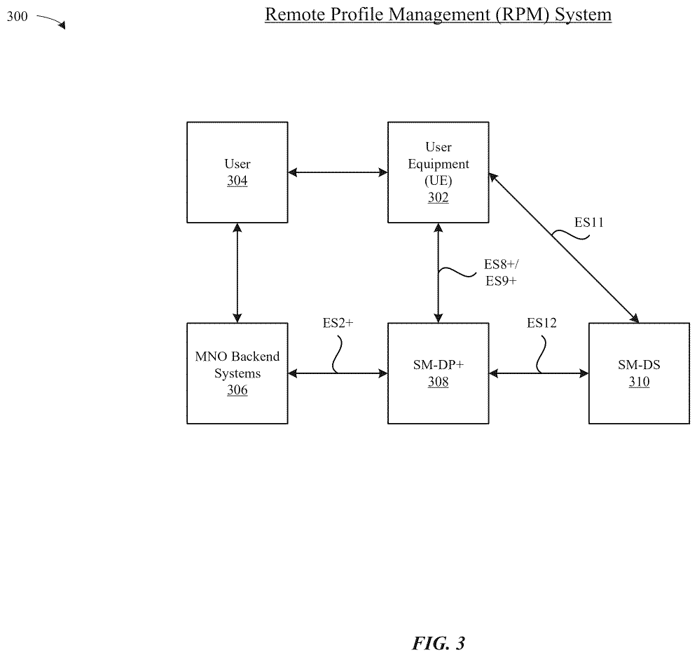

FIG. 3 illustrates a block diagram 300 of an exemplary system for providing remote profile management (RPM) of one or more eSIMs 208 stored on an eUICC 108 of a user equipment (UE) 302. A user 304 of the UE 302 can interact with MNO backend systems 306 associated with an MNO 114 to obtain and/or manage an eSIM 208 for the UE 302, e.g., to subscribe to and/or modify cellular wireless service provided by the MNO 114 via credentials of the eSIM 208. The MNO backend systems 306 can communicate via an ES2+ interface with an MNO provisioning server 116, e.g., a subscription manager data preparation plus (SM-DP+) server 308, to order preparation of an eSIM 208, provide an update to an eSIM 208 for the UE 302, and/or provide other eSIM 208 administrative functions. The SM-DP+ 308 can be connected via an ES12 interface to a subscription manager discovery server (SM-DS) 310 that can be accessed by the UE 302 via an ES11 interface. The SM-DP+ 308 can communicated via the ES12 interface to register event records for the UE 302 at the SM-DS 310. The SM-DP+ 308 can also delete event records for the UE 302 at the SM-DS 310 via messages over the ES12 interface. The SM-DS 310 can aggregate eSIM profile events for the UE 302 for one or more MNOs 114 and provide notification to the UE 302, via the ES11 interface, of availability of one or more eSIM profile events for the eUICC 108 of the UE 302, e.g., via a push notification message to the UE 302, responsive to a pull notification message from the UE 302, where notification can occur periodically at regular intervals and/or manually on demand. The SM-DS 310 can provide information over the ES11 interface via notification messages to the UE 302 regarding an eSIM 208 available to download to the eUICC 108 of the UE 302 and/or an eSIM RPM procedure to be executed for an eSIM 208 on the eUICC 108 of the UE 302. The eUICC 108 of the UE 302 can communicate with the SM-DP+ 308 via an ES8+ interface to manage download an installation of an eSIM 208 profile from the SM-DP+ 308 to the eUICC 108 of the UE 302. An LPA of the UE 302 can also communicate with the SM-DP+308 via an ES9+ interface to provide secure transport and management of a bound profile package (BPP) that securely contains an eSIM 208 and/or to provide for RPM procedures for one or more eSIM 208 on the eUICC 108 of the UE 302.

In some embodiments, a user 304 can obtain a UE 302 and sign up for a cellular wireless subscription, e.g., via a retail outlet and/or via an online store, and certain information can be established to identify the user 304 by an MNO backend system 306. In some embodiments, the MNO backend system 306 can specify information to be obtained (at a subsequent time) from the UE 302 (or the user 304 thereof) to verify authority of the user to perform a cellular wireless service procedure, e.g., downloading and installing an eSIM 208 on the eUICC 108 of the UE 302. The MNO backend system 306, in some embodiments, can provide a submit order message to the SM-DP+ 308 to specify the information to be obtained, where the submit order message can include one or more fields as described herein for an extensible user challenge. Subsequently, during the cellular wireless service procedure, e.g., responsive to a request to download an eSIM 208 to the UE 302, the SM-DP+ 308 can obtain the required information for verification, e.g., where checking of the information can occur at the MNO backend system 306 and/or at the SM-DP+ 308. When information obtained from the UE 302 is verified, the cellular wireless procedure can proceed. When information obtained from the UE 302 is not verified, the SM-DP+ can execute an error recovery procedure to re-attempt to obtain the required information, and the cellular wireless procedure can be suspended until the required information is obtained.

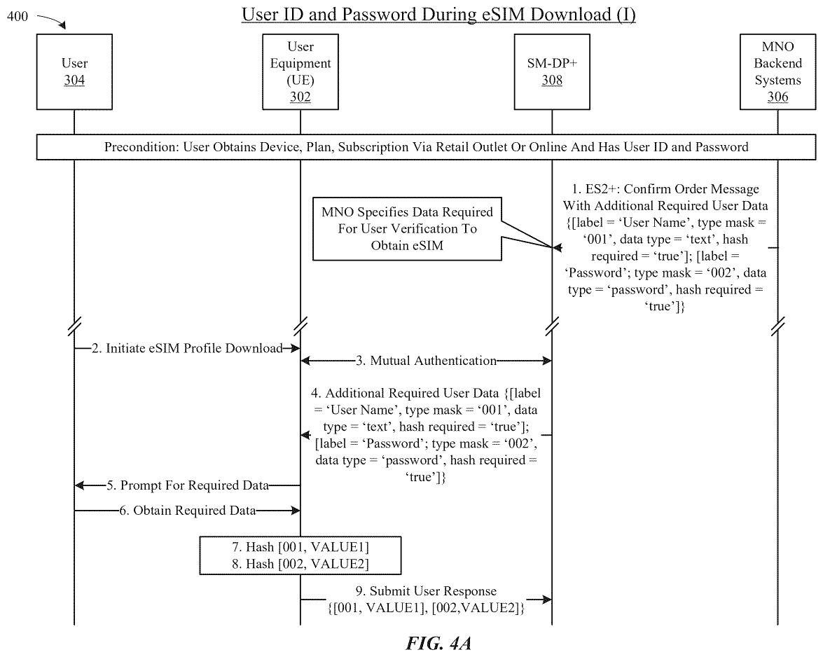

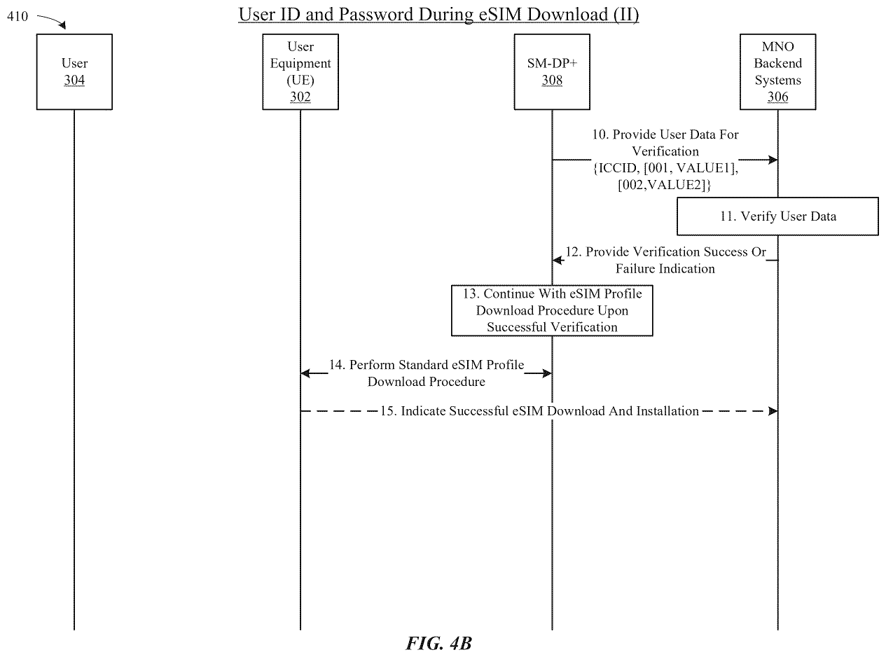

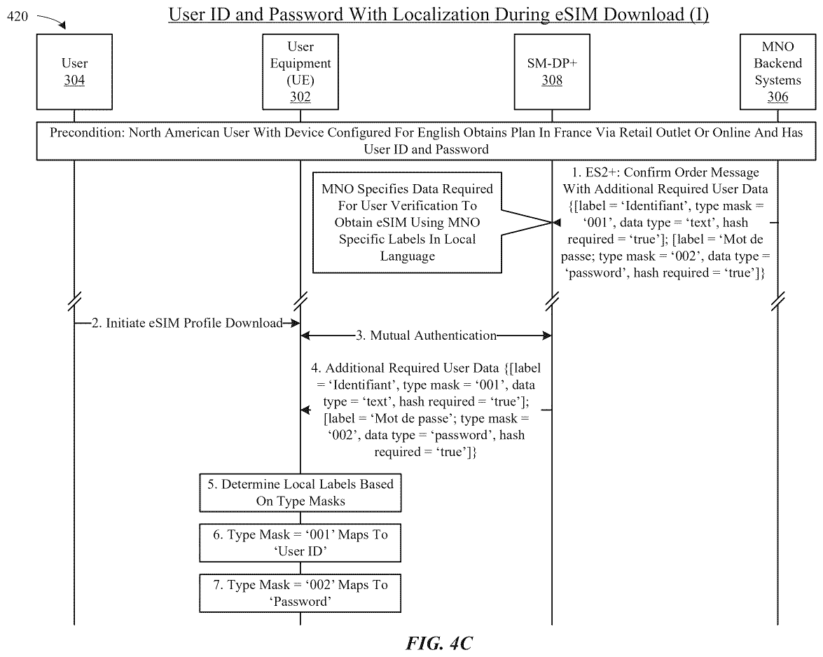

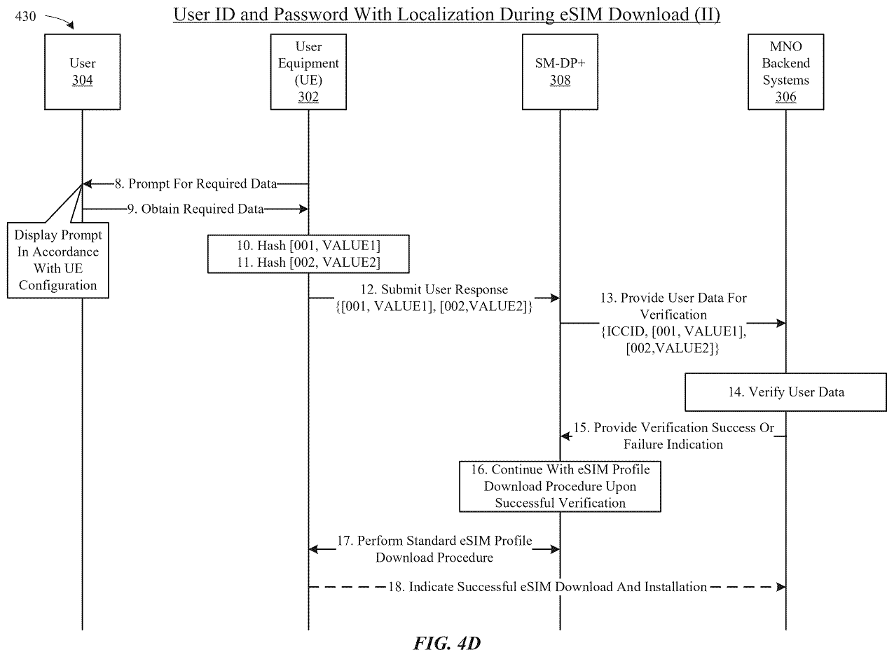

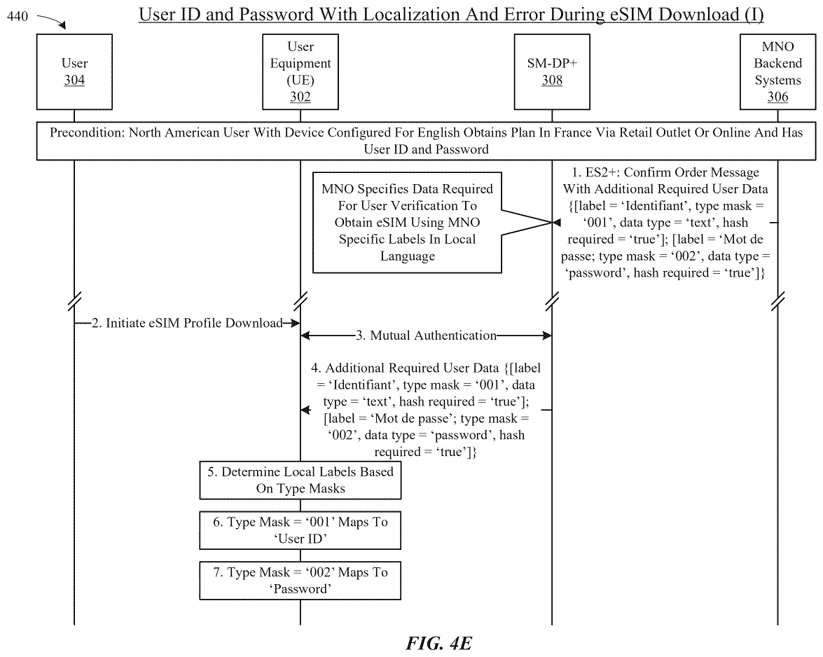

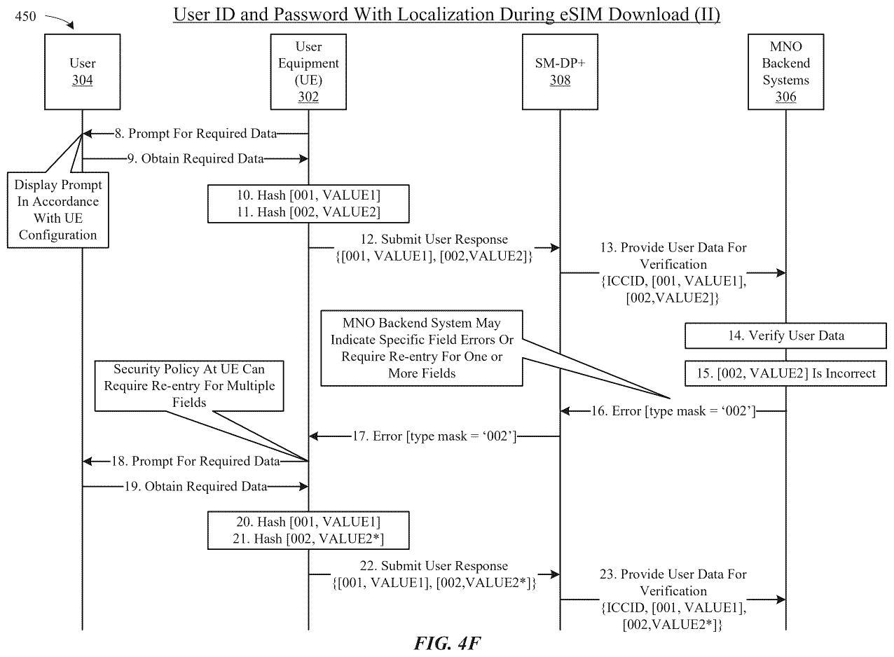

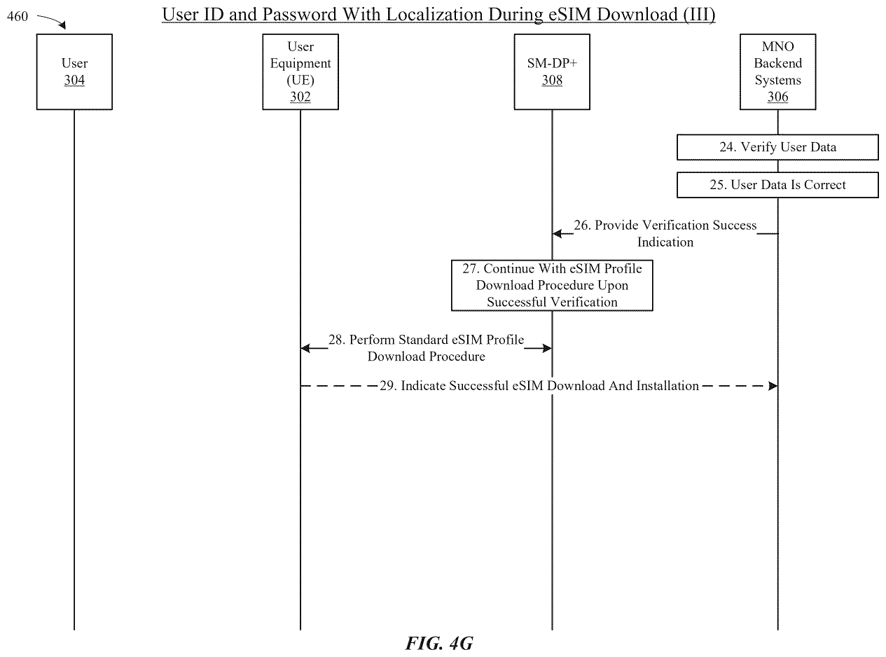

FIGS. 4A and 4B illustrate flow diagrams 400, 410 of an exemplary scenario where a download event for an eSIM 208, which is to be installed on an eUICC 108 of a wireless device, e.g., UE 302, requires verification of a user identification (ID) and password by an MNO backend system 306 before the eSIM 208 can be released for download and installation to the eUICC 108 of the UE 302. Beginning with flow diagram 400 of FIG. 4A, as a precondition, a user 304 can obtain a UE 302, which can be associated with a cellular wireless service subscription and/or a specific cellular wireless plan of an MNO 114, such as via a purchase at a retail outlet or online, where the user 304 is associated with (or creates an association at the MNO 114) with a user identifier (ID) and a password. This data can be required at subsequent times by the MNO 114 to be verified by the MNO backend system 306 before starting or continuing a cellular wireless service procedure, such as providing an eSIM 208 to the UE 302. At step 1, the MNO backend system 306 sends a confirm order message via an ES2+ interface to an SM-DP+ 308. The confirm order message is augmented to include MNO specific user data that is to be obtained from the UE 302 (and/or the user 304 thereof) and verified before an eSIM 208 reserved for the UE 302 can be provided to the UE 302. As indicated at step 1, the ES2+ confirm order message can include an extensible, customizable list of additional required user data, namely, for this particular exemplary embodiment, the required data includes the user ID, referred by the label ‘User Name’ and the associated password of the user 304. Each user data point required by the MNO 114 can be specified in the ES2+ confirm order message by one or more fields, such as a descriptive label, a standardized type mask value, a data type value, an indication of whether hashing is required for the user data point, and optionally an error type mask. A descriptive label can be a text string that describes the data required by the MNO 114, where the text string can be specified by the MNO 114. When no type mask is specified, the descriptive label can be used in a user-facing field description to specify the data point required. A type mask field provides a standardized representation of a data point required by an MNO 114. A neutral third party, e.g., a standards organization such as the GSMA or ITUT, can maintain a logical list of type mask values to particular types of data. For example a type mask value of ‘001’ can be associated with a user name, a type mask value of ‘002’ can be associated with a password, a type mask value of ‘099’ can be associated with a passport number, etc. A pre-existing mapping of type mask values to localized, user-friendly labels can be defined by an original equipment manufacturer (OEM) of the UE 302 to provide an indication with language and terminology applicable to the user 304 of the UE 302, e.g., based on configuration of the UE 302 by the user 304. A data type can be specified for each data point, and various data types can be supported, e.g., plain text, user name, password, email address, address with country code for correct coding, image file (e.g., photo ID), quick response (QR) scan, file/document, universal record locator (URL) for MNO 114 and/or regulatory (governmental) servers for verification, etc. With knowledge of the data type required, a user interface of the UE 302 can present input options to obtain a data point in an appropriate format. An indication of whether hashing is required for the data point can also be specified, e.g., via a Boolean flag, where ‘false’ can indicate that hashing of the data field value is not required (e.g., plain text acceptable) while ‘true’ can indicate that the data field value must be hashed by a processing component of the UE 302 prior to providing to a server of the MNO 114, e.g., to the SM-DP+ 308 and/or the MNO backend system 306, for verification. In some embodiments, an optional hash field that specifies a particular hash algorithm to be used can be included in the list for the data point. In some embodiments, the particular hash algorithm can be specified by a hash algorithm type mask. In some embodiments, a default hash algorithm can be used, such as SHA256, when a particular hash algorithm is not specified.

At step 2, a user 304 of the UE 302 can initiate provisioning of an eSIM 208 to the UE 302. At step 3, the UE 302 performs a common mutual authentication procedure with the SM-DP+ 308. At step 4, the SM-DP+ 308 sends a message to the UE 302 indicating additional user data that is required for the requested eSIM download procedure to progress. The additional user data required can be specified using a list of required user data points, e.g., using the same format as specified in the ES2+ confirm order message received by the SM-DP+ 308 from the MNO backend system 306. At step 5, the UE 302 can prompt the user 304 for the required data, e.g., via a locally customized user interface that presents the request for the required data in a user-friendly format. At step 6, the UE 302 obtains values for the required data points from the user 304, e.g., a user name value and a password value. As specified by the MNO backend system 306 at step 1 and by the SM-DP+ 308 at step 4, the UE 302 can be required to apply a hashing algorithm to the two required data points. At steps 7 and 8, the UE 302 can apply the hashing algorithm to each of the user name value and the password value to create a hashed user name value (indicated as VALUE1) and a hashed password value (indicated as VALUE2). At step 9, the UE 302 can provide a user response to the SM-DP+ 308 with the hashed versions of the required user data point values. In some embodiments, the hashed versions of the user data point values are communicated in an ordered list, with each user data point specified by a type mask value and an associated user data point value (which can be a hashed version of the user supplied data point value).

Continuing with flow diagram 410 of FIG. 4B, at step 10, the SM-DP+ 308 provides the user data to the MNO backend system 306 for verification. In some embodiments, the user data points are communicated in an ordered list, which can include an integrated circuit card identifier (ICCID) value for the eSIM 208 that is associated with the UE 302 (and/or with a cellular wireless service subscription account of the user 304 of the UE 302) along with each user data point specified by a type mask value and an associated user data point value (which can be a hashed version of the user supplied data point value). At step 11, the MNO backend system 306 can compare the provided user data with existing user data values known to the MNO backend system 306 to verify validity of the user data and determine (at least part) that the UE 302 and/or the user 304 is authorized for the requested cellular wireless service procedure, e.g., to obtain the reserved eSIM 308 from the SM-DP+ 308. At step 12, the MNO backend system 306 provides an indication of verification success or failure to the SM-DP+ 308. At step 13, the SM-DP+ 308 can determine whether to continue with the eSIM 208 profile download procedure for the UE 302. Upon a successful verification by the MNO backend system 306 and verification success indication obtained, the SM-DP+ 308, at step 14, can initiate (or continue) performance of a standard eSIM 208 profile download procedure with the UE 302. At step 15, the UE 302 can optionally provide an indication to the MNO backend system 306 of a successful eSIM 208 download and installation on the eUICC 108 of the UE 302.

In some embodiments, verification of one or more user data points can occur at the SM-DP+ 308, e.g., where a hashed static data value can be provided by the MNO backend system 306 to the SM-DP+ 308, where a comparison of hashed data values can occur without revealing underlying plain text user data values. In some regions and/or countries, a “know your customer” (KYC) regulation can require that additional data points be obtained from a user 304 before allowing an eSIM 208 profile download to occur, e.g., collect a passport number, where the additional data point can be verified by a third party system, e.g., other than the MNO backend system 306, as a valid value for the additional data point may not be known by the MNO 114.

FIGS. 4C and 4D illustrate flow diagrams 420, 430 of another example of an extensible user challenge for user verification based on user identification (ID) password values with localization by a UE 302 for an eSIM 208 profile download procedure. The example illustrated in FIGS. 4C and 4D is similar to that shown in FIGS. 4A and 4B with additional language localization provided. Beginning with flow diagram 420 of FIG. 4C, as a precondition, a North American user 304 with a wireless device 102, e.g., UE 302, configured for a particular language, e.g., English, subscribes to a cellular wireless service plan from an MNO 114 to be used in France, e.g., via a purchase at a retail outlet or online, where the user 304 has established a user ID and password with the MNO 114 and associated with subscription to the cellular wireless service plan for the MNO 114. The user ID and password can be required by the MNO 114 to be provided for verification before delivery of an eSIM 208 profile for the cellular wireless service plan to which the user 304 subscribed is allowed to be downloaded to the UE 302. At step 1, the MNO backend system 306 sends a confirm order message via an ES2+ interface to an SM-DP+ 308. The confirm order message is augmented to include MNO specific user data that is to be obtained from the UE 302 (and/or the user 304 thereof) and verified before an eSIM 208 reserved for the UE 302 can be provided to the UE 302. As indicated at step 1, the ES2+ confirm order message can include an extensible, customizable list of additional required user data, namely, for this particular exemplary embodiment, the required data includes the user ID, referred by the MNO 114 supplied label ‘Identifiant’ in French for the service to be used in France, and the associated password of the user 304, referred to by the label ‘Mot de passe’. The confirm order message includes standardized type mask values ‘001’ and ‘002’ associated with the data points for which values are to be obtained along with data type values and indications of whether hashing of the user data values is to be applied. The MNO 114 specifies the data points required for user verification to obtain the eSIM 208 profile using MNO specific labels in a local language; however, with use of the standardized type mask values, the UE 302 can obtain the required data points via a user interface that is user-specific to a configuration of the UE 302 (separate from the language used by the MNO 114). At step 2, a user 304 of the UE 302 can initiate provisioning of an eSIM 208 to the UE 302. At step 3, the UE 302 performs a common mutual authentication procedure with the SM-DP+ 308. At step 4, the SM-DP+ 308 sends a message to the UE 302 indicating additional user data that is required for the requested eSIM download procedure to progress. The additional user data required can be specified using a list of required user data points, e.g., using the same format as specified in the ES2+ confirm order message received by the SM-DP+ 308 from the MNO backend system 306. At step 5, the UE 302 determines applicable localized labels that are in a format appropriate for the OEM and understandable to the user, e.g., based on a preferred language and/or configuration of the UE 302. The UE 302 can use the standardized type mask values to determine labels to use when requesting data from the user 304 to satisfy the MNO 114 requirements for additional data. At step 6, the UE 302 determines that the type mask value ‘001’, which accompanies the label ‘Identifiant’ in the message received from the SM-DP+ 308, corresponds to a ‘User ID’ label applicable for display to the user 304 of the UE 302. At step 7, the UE 302 determines that the type mask value ‘002’, which accompanies the label ‘Mot de passe’ in the message received from the SM-DP+ 308, corresponds to a ‘Password’ label applicable for display to the user 304 of the UE 302.

Continuing with flow diagram 430 of FIG. 4D, at step 8, the UE 302 can prompt the user 304 for the required data, e.g., via a locally customized user interface that presents the request for the required data in a user-friendly format. At step 9, the UE 302 obtains values for the required data points from the user 304, e.g., a user name value and a password value. As specified by the MNO backend system 306 at step 1 and by the SM-DP+ 308 at step 4, the UE can be required to apply a hashing algorithm to the two required data points. At steps 10 and 11, the UE 302 can apply the hashing algorithm to each of the user name value and the password value to create a hashed user name value (indicated as VALUE1) and a hashed password value (indicated as VALUE2). At step 12, the UE 302 can provide a user response to the SM-DP+ 308 with the required user data point values. In some embodiments, the user data points are communicated in an ordered list, with each user data point specified by a type mask value and an associated user data point value (which can be a hashed version of the user supplied data point value). At step 13, the SM-DP+ 308 provides the user data to the MNO backend system 306 for verification. In some embodiments, the user data points are communicated in an ordered list, which can include an integrated circuit card identifier (ICCID) value for the eSIM 208 that is associated with the UE 302 (and/or with a cellular wireless service subscription account of the user 304 of the UE 302) along with each user data point specified by a type mask value and an associated user data point value (which can be a hashed version of the user supplied data point value). At step 14, the MNO backend system 306 can compare the provided user data with existing user data values known to the MNO backend system 306 to verify validity of the user data and determine (at least part) that the UE 302 and/or the user 304 is authorized for the requested cellular wireless service procedure, e.g., to obtain the reserved eSIM 308 from the SM-DP+ 308. At step 15, the MNO backend system 306 provides an indication of verification success or failure to the SM-DP+ 308. At step 16, the SM-DP+ can determine whether to continue with the eSIM 208 profile download procedure for the UE 302. Upon a successful verification by the MNO backend system 306 and verification success indication obtained, the SM-DP+ 308, at step 17, can initiate (or continue) performance of a standard eSIM 208 profile download procedure with the UE 302. At step 18, the UE 302 can optionally provide an indication to the MNO backend system 306 of a successful eSIM 208 download and installation on the eUICC 108 of the UE 302.

FIGS. 4E, 4F, and 4G illustrate flow diagrams 440, 450, 460 of a further example of an extensible user challenge for user verification based on user identification (ID) password values with localization by a UE 302 for an eSIM 208 download procedure with additional error recovery. Beginning with flow diagram 440 of FIG. 4E, as a precondition, a North American user 304 with a wireless device 102, e.g., UE 302, configured for a particular language, e.g., English, subscribes to a cellular wireless service plan from an MNO 114 to be used in France, e.g., via a purchase at a retail outlet or online, where the user 304 has established a user ID and password with the MNO 114 and associated with subscription to the cellular wireless service plan for the MNO 114. The user ID and password can be required by the MNO 114 to be provided for verification before delivery of an eSIM 208 profile for the cellular wireless service plan to which the user 304 subscribed is allowed to be downloaded to the UE 302. At step 1, the MNO backend system 306 sends a confirm order message via an ES2+ interface to an SM-DP+ 308. The confirm order message is augmented to include MNO specific user data that is to be obtained from the UE 302 (and/or the user 304 thereof) and verified before an eSIM 208 reserved for the UE 302 can be provided to the UE 302. As indicated at step 1, the ES2+ confirm order message can include an extensible, customizable list of additional required user data, namely, for this particular exemplary embodiment, the required data includes the user ID, referred by the MNO 114 supplied label ‘Identifiant’ in French for the service to be used in France, and the associated password of the user 304, referred to by the label ‘Mot de passe’. The confirm order message includes standardized type mask values ‘001’ and ‘002’ associated with the data points for which values are to be obtained along with data type values and indications of whether hashing of the user data values is to be applied. The MNO 114 specifies the data points required for user verification to obtain the eSIM 208 profile using MNO specific labels in a local language; however, with use of the standardized type mask values, the UE 302 can obtain the required data points via a user interface that is user-specific to a configuration of the UE 302 (separate from the language used by the MNO 114). At step 2, a user 304 of the UE 302 can initiate provisioning of an eSIM 208 to the UE 302. At step 3, the UE 302 performs a common mutual authentication procedure with the SM-DP+ 308. At step 4, the SM-DP+ 308 sends a message to the UE 302 indicating additional user data that is required for the requested eSIM download procedure to progress. The additional user data required can be specified using a list of required user data points, e.g., using the same format as specified in the ES2+ confirm order message received by the SM-DP+ 308 from the MNO backend system 306. At step 5, the UE 302 determines applicable localized labels that are in a format appropriate for the OEM and understandable to the user, e.g., based on a preferred language and/or configuration of the UE 302. The UE 302 can use the standardized type mask values to determine labels to use when requesting data from the user 304 to satisfy the MNO 114 requirements for additional data. At step 6, the UE 302 determines that the type mask value ‘001’, which accompanies the label ‘Identifiant’ in the message received from the SM-DP+ 308, corresponds to a ‘User ID’ label applicable for display to the user 304 of the UE 302. At step 7, the UE 302 determines that the type mask value ‘002’, which accompanies the label ‘Mot de passe’ in the message received from the SM-DP+ 308, corresponds to a ‘Password’ label applicable for display to the user 304 of the UE 302.

Continuing with flow diagram 450 of FIG. 4F, at step 8, the UE 302 can prompt the user 304 for the required data, e.g., via a locally customized user interface that presents the request for the required data in a user-friendly format. At step 9, the UE 302 obtains values for the required data points from the user 304, e.g., a user name value and a password value. As specified by the MNO backend system 306 at step 1 and by the SM-DP+ 308 at step 4, the UE can be required to apply a hashing algorithm to the two required data points. At steps 10 and 11, the UE 302 can apply the hashing algorithm to each of the user name value and the password value to create a hashed user name value (indicated as VALUE1) and a hashed password value (indicated as VALUE2). At step 12, the UE 302 can provide a user response to the SM-DP+ 308 with the required user data point values. In some embodiments, the user data points are communicated in an ordered list, with each user data point specified by a type mask value and an associated user data point value (which can be a hashed version of the user supplied data point value). At step 13, the SM-DP+ 308 provides the user data to the MNO backend system 306 for verification. In some embodiments, the user data points are communicated in an ordered list, which can include an integrated circuit card identifier (ICCID) value for the eSIM 208 that is associated with the UE 302 (and/or with a cellular wireless service subscription account of the user 304 of the UE 302) along with each user data point specified by a type mask value and an associated user data point value (which can be a hashed version of the user supplied data point value). At step 14, the MNO backend system 306 can compare the provided user data with existing user data values known to the MNO backend system 306 to verify validity of the user data and determine (at least part) that the UE 302 and/or the user 304 is authorized for the requested cellular wireless service procedure, e.g., to obtain the reserved eSIM 308 from the SM-DP+ 308. At 15, the MNO backend system 306 determines that at least one data point value does not match an expected value, e.g., the hashed version of the password, communicated as VALUE2, does not correspond to a hashed version of the password maintained by (and/or known to) the MNO backend system 306. At 16, the MNO backend system 306 sends a message to the SM-DP+ indicating a verification failure has occurred and can specify an error in particular supplied user data point values, e.g., an error in the data point value supplied corresponding to the type mask value ‘002’. The MNO backend system 306 can specify which data point errors have occurred and/or can require re-entry of one or more data points. At 17, the SM-DP+ 308 sends a message to the UE 302 indicating an error in particular supplied user data point values, e.g., an error in the data point value supplied corresponding to the type mask value ‘002’. At 18, the UE 302 can prompt the user 304 to re-enter one or more required data point values. In some embodiments, a security policy at the UE 302 can require re-entry of multiple data point values in response to an error in one or more data point values. In the example illustrated in FIG. 4F, the MNO backend system 306 via the SM-DP+ 308 indicated an error in the data point value corresponding to the type mask value ‘002’, i.e., a password value is in error. The UE 302 can determine, based on a local security policy set by the OEM of the UE 302 and/or by the MNO 114, to require re-entry of multiple fields, e.g., obtain both the password value and a corresponding user name value again. At 19, the UE 302 obtains the required re-entered user data points. At steps 20 and 21, the UE 302 can apply the hashing algorithm to each of the re-entered user name value and the re-entered password value to create a hashed user name value (indicated as VALUE1) and a hashed password value (indicated as VALUE2* to distinguish from the previously provided errant VALUE2). At step 22, the UE 302 can provide an updated user response to the SM-DP+ 308 with the required, re-entered user data point values. In some embodiments, the user data points are communicated in an ordered list, with each user data point specified by a type mask value and an associated user data point value (which can be a hashed version of the user supplied data point value). At step 23, the SM-DP+ 308 provides the re-entered user data to the MNO backend system 306 for verification. In some embodiments, the user data points are communicated in an ordered list, which can include an integrated circuit card identifier (ICCID) value for the eSIM 208 that is associated with the UE 302 (and/or with a cellular wireless service subscription account of the user 304 of the UE 302) along with each user data point specified by a type mask value and an associated user data point value (which can be a hashed version of the user supplied data point value).

Continuing with flow diagram 460 of FIG. 4G, at step 24, the MNO backend system 306 can compare the provided user data with existing user data values known to the MNO backend system 306 to verify validity of the user data and determine (at least part) that the UE 302 and/or the user 304 is authorized for the requested cellular wireless service procedure, e.g., to obtain the reserved eSIM 308 from the SM-DP+ 308. At step 25, the MNO backend system 306 determines that the newly provided user data point values match and user verification is successful. At step 26, the MNO backend system 306 provides an indication of verification success to the SM-DP+ 308. Upon a successful verification by the MNO backend system 306 and verification success indication obtained, the SM-DP+ 308, at step 27, can determine to continue with eSIM 208 profile download procedure with the UE 302. At step 28, the SM-DP+ 308 executes the eSIM 208 profile download procedure with the UE 302. At step 29, the UE 302 can optionally provide an indication to the MNO backend system 306 of a successful eSIM 208 download and installation on the eUICC 108 of the UE 302.

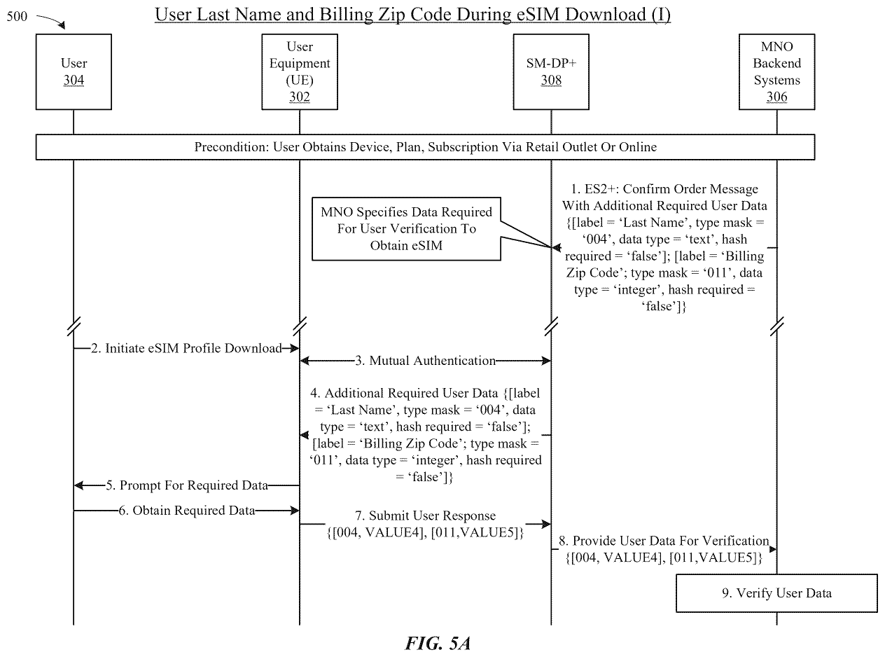

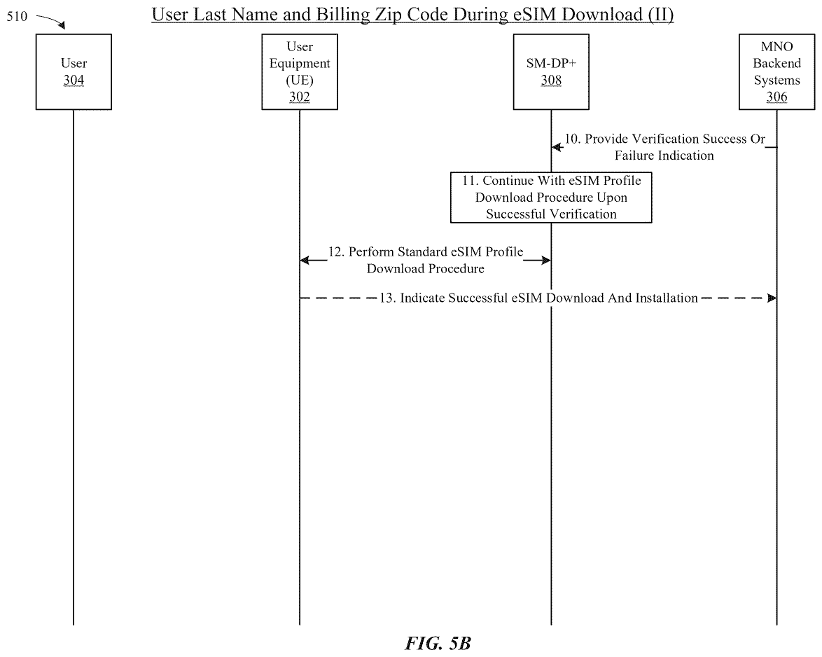

FIGS. 5A and 5B illustrate flow diagrams 500, 510 of an example of an extensible user challenge for user verification based on verification of a user last name value and a billing zip code value before an eSIM 208 can be released for download and installation to an eUICC 108 of a UE 302. Beginning with flow diagram 500 of FIG. 5A, as a precondition, a user 304 can obtain a UE 302, which can be associated with a cellular wireless service subscription and/or a specific cellular wireless plan of an MNO 114, such as via a purchase at a retail outlet or online, where the user 304 provides personal information such as their last name and a billing zip code for a credit card used for purchase of the UE 302. In some embodiments, the user 304 purchases a cellular wireless service subscription from the MNO 114 for an existing UE 302 (already used by the user 304). Specific user data can be required by the MNO 114 to be verified by the MNO backend system 306 before starting or continuing a cellular wireless service procedure, such as for providing an eSIM 208 associated with the cellular wireless service subscription to the UE 302. At step 1, the MNO backend system 306 sends a confirm order message via an ES2+ interface to an SM-DP+ 308. The confirm order message is augmented to include MNO specific user data that is to be obtained from the UE 302 (and/or the user 304 thereof) and verified before an eSIM 208 reserved for the UE 302 can be provided to the UE 302. As indicated at step 1, the ES2+ confirm order message can include an extensible, customizable list of additional required user data, namely, for this particular exemplary embodiment, the required data includes a user last (family) name, referred by the label ‘Last Name’ and a billing zip code, referred by the label ‘Billing Zip Code’, associated with the user 304. Each user data point required by the MNO 114 can be specified in the ES2+ confirm order message by one or more fields, such as a descriptive label, a standardized type mask value, a data type value, an indication of whether hashing is required for the user data point, and optionally an error type mask. For the particular example illustrated in FIG. 5A, a type mask value of ‘004’ can be associated with a user last (family) name, while a type mask value of ‘011’ can be associated with a credit card billing zip code. A data type can be specified for each data point, e.g., a text data type for the last (family) name and an integer data type for the credit card billing zip code. An indication of whether hashing is required can also be provided for each data point. For this example, hashing of the data point values obtained from the user 304 is not required.

At step 2, a user 304 of the UE 302 can initiate provisioning of an eSIM 208 to the UE 302. At step 3, the UE 302 performs a common mutual authentication procedure with the SM-DP+ 308. At step 4, the SM-DP+ 308 sends a message to the UE 302 indicating additional user data that is required for the requested eSIM download procedure to progress. The additional user data required can be specified using a list of required user data points, e.g., using the same format as specified in the ES2+ confirm order message received by the SM-DP+ 308 from the MNO backend system 306. At step 5, the UE 302 can prompt the user 304 for the required data, e.g., via a locally customized user interface that presents the request for the required data in a user-friendly format. At step 6, the UE 302 obtains values for the required data points from the user 304, e.g., a user name value and a password value. At step 7, the UE 302 can provide a user response to the SM-DP+ 308 with the required user data point values. In some embodiments, the user data points are communicated in an ordered list, with each user data point specified by a type mask value and an associated user data point value. In this example, hashing is not required for the supplied user data point values, and the information can be supplied to the SM-DP+ 308 in plain text. (The communication link between the UE 302 and the SM-DP+ 308 can use encryption, and therefore the plain text data is still protected from snooping.) At step 8, the SM-DP+ 308 provides the user data to the MNO backend system 306 for verification. In some embodiments, the user data points are communicated in an ordered list, which can include an integrated circuit card identifier (ICCID) value for the eSIM 208 that is associated with the UE 302 (and/or with a cellular wireless service subscription account of the user 304 of the UE 302) along with each user data point specified by a type mask value and an associated user data point value. At step 9, the MNO backend system 306 can compare the provided user data with existing user data values known to the MNO backend system 306 to verify validity of the user data and determine (at least part) that the UE 302 and/or the user 304 is authorized for the requested cellular wireless service procedure, e.g., to obtain the reserved eSIM 308 from the SM-DP+ 308.

Continuing with flow diagram 510 of FIG. 5B, at step 10, the MNO backend system 306 provides an indication of verification success or failure to the SM-DP+ 308. At 11, the SM-DP+ can determine whether to continue with the eSIM 208 profile download procedure for the UE 302. Upon a successful verification by the MNO backend system 306 and verification success indication obtained, the SM-DP+ 308, at step 12, can initiate (or continue) performance of a standard eSIM 208 profile download procedure with the UE 302. At step 13, the UE 302 can optionally provide an indication to the MNO backend system 306 of a successful eSIM 208 download and installation on the eUICC 108 of the UE 302.

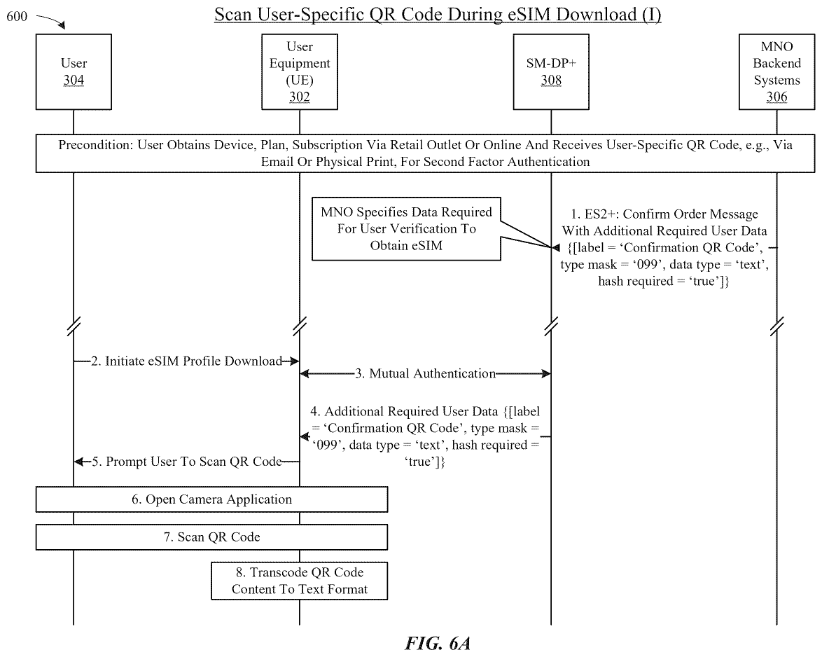

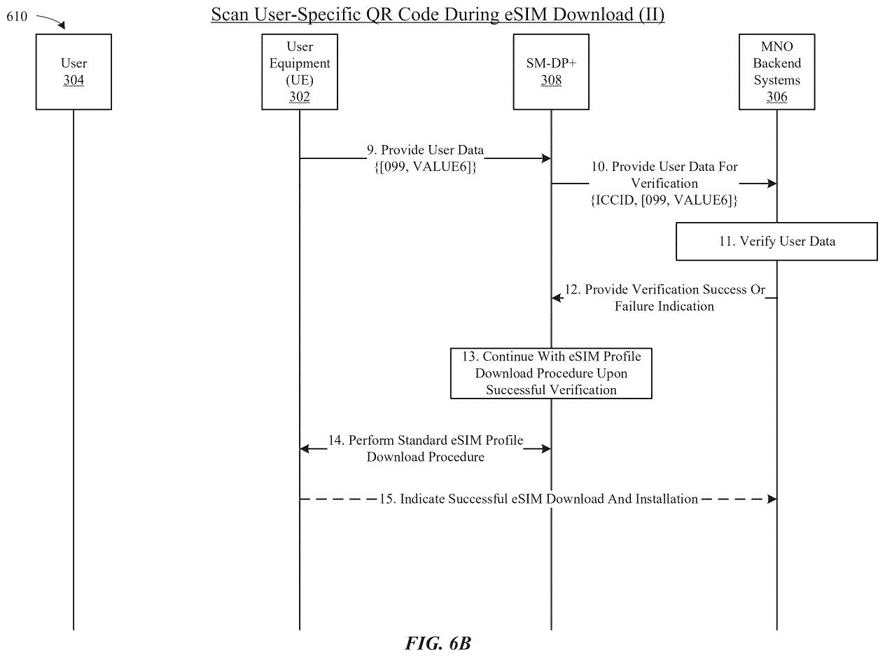

FIGS. 6A and 6B illustrate flow diagrams 600, 610 of an example of an extensible user challenge for user verification based on a scan of a user-specific quick response (QR) code for an eSIM 208 download procedure. Beginning with flow diagram 600 of FIG. 6A, as a precondition, a user can obtain a UE 302, which can be associated with a cellular wireless service subscription and/or a specific cellular wireless plan of an MNO 114, such as via a purchase at a retail outlet or online, where the user 304 receives a user-specific QR code, such as via an email or a physical printout, where the user-specific QR code can be used for second factor authentication. In some embodiments, user 304 purchases a cellular wireless service subscription from the MNO 114 for an existing UE 302 (already used by the user 304). The MNO 114 can require the QR code for verification of the user 304 to release an eSIM 308 reserved for the UE 302. At step 1, the MNO backend system 306 sends a confirm order message via an ES2+ interface to an SM-DP+ 208. The confirm order message is augmented to include MNO specific user data to be obtained from the UE 302 (and/or from the user 304 thereof) and verified before releasing an eSIM 208 to the UE 302. As indicated at step 1, the DS2+ confirm order message includes an extensible, customizable list of additional required user data, namely, for this particular exemplary embodiment, the required data includes a QR code, referred by the label ‘Confirmation QR Code’ also specified by the type mask ‘099’. A scan of a QR code can be transcoded to a text string and therefore the QR code is indicated as a ‘text’ data type. Additionally, a hashing algorithm can be required to be applied to the scanned QR code before communicated from the UE 302 to the SM-DP+ 308.

At step 2, a user 304 of the UE 302 can initiate provisioning of an eSIM 208 to the UE 302. At step 3, the UE 302 performs a common mutual authentication procedure with the SM-DP+ 308. At step 4, the SM-DP+ 308 sends a message to the UE 302 indicating additional user data that is required for the requested eSIM download procedure to progress. The additional user data required can be specified using a list of required user data points, e.g., using the same format as specified in the ES2+ confirm order message received by the SM-DP+ 308 from the MNO backend system 306. In this case, the SM-DP+ 308 indicates to the UE 302 that a confirmation QR code is required. At step 5, the UE 302 can prompt the user 304 to scan a QR code. The UE 302 can be configured to provide an appropriate user interface and activate applications and/or hardware as required to allow for scanning the QR code. At step 6, the UE 302 (and/or the user 304) can open a camera application of the UE 302. At step 7, the user 304 can cause the UE 302 to scan the user-specific QR code previously received (e.g., scanning information from a print out of an email or hard copy of a QR code provided by the MNO 114 associated with the eSIM 208 to be provided to the UE 302 to access cellular wireless service of the MNO 114). At step 8, the UE 302 can transcode content of the scanned QR code to a text format. In some embodiments, transcoding can further include applying a hashing algorithm to the resulting text formatted, scanned QR code.

Continuing with the flow diagram 610 of FIG. 6B, at step 9, the UE 302 provides a user response to the SM-DP+ 308 with the required user data point values. In some embodiments, the user data points are communicated in an ordered list, with each user data point specified by a type mask value and an associated user data point value (or a hashed version of the user data point value). At step 10, the SM-DP+ 308 provides the user data to the MNO backend system 306 for verification. In some embodiments, the user data points are communicated in an ordered list, which can include an integrated circuit card identifier (ICCID) value for the eSIM 208 that is associated with the UE 302 (and/or with a cellular wireless service subscription account of the user 304 of the UE 302) along with each user data point specified by a type mask value and an associated user data point value. At step 11, the MNO backend system 306 can compare the provided user data with existing user data values known to the MNO backend system 306 to verify validity of the user data and determine (at least part) that the UE 302 and/or the user 304 is authorized for the requested cellular wireless service procedure, e.g., to obtain the reserved eSIM 308 from the SM-DP+ 308. At step 12, the MNO backend system 306 provides an indication of verification success or failure to the SM-DP+ 308. At step 13, the SM-DP+ can determine whether to continue with the eSIM 208 profile download procedure for the UE 302. Upon a successful verification by the MNO backend system 306 and verification success indication obtained, the SM-DP+ 308, at step 14, can initiate (or continue) performance of a standard eSIM 208 profile download procedure with the UE 302. At step 15, the UE 302 can optionally provide an indication to the MNO backend system 306 of a successful eSIM 208 download and installation on the eUICC 108 of the UE 302.

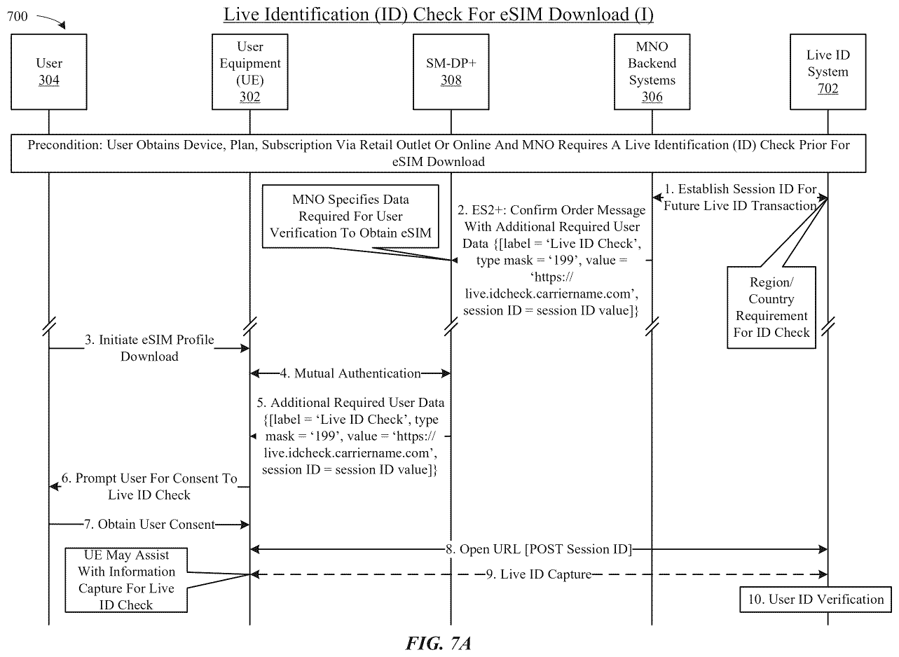

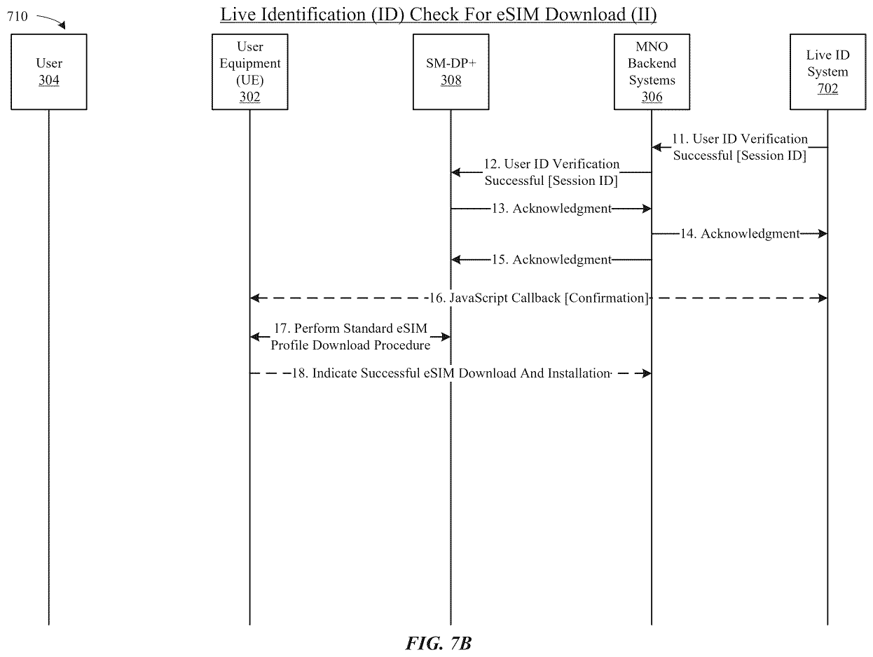

FIGS. 7A and 7B illustrate flow diagrams 700, 710 of an example of an extensible user challenge for user verification based on a live identification (ID) check via a third-party system to verify a user 304 before allowing a cellular wireless service procedure, e.g., an eSIM 208 download procedure, for a UE 302. Beginning with flow diagram 700 of FIG. 7A, as a precondition, a user 304 can obtain a UE 302, which can be associated with a cellular wireless service subscription and/or a specific cellular wireless plan of an MNO 114, such as via a purchase at a retail outlet or online, where the MNO 114 requires a live identification (ID) check prior to permitting the cellular wireless service procedure, e.g., download of an eSIM 208 reserved for the UE 302, to occur. In some embodiments, the user 304 purchases a cellular wireless service subscription from the MNO 114 for an existing UE 302 (already used by the user 304). In some embodiments, the live ID check can be performed via communication with a live ID system 702, which may be managed by a third party entity, by the MNO 114, by a governmental agency, or the like. At step 1, the MNO backend system 306 communicates with the Live ID system 702 to establish a session identifier (ID) values for a future live ID transaction for the UE 302 (and for the user 304 thereof). In some embodiments, there is a regional and/or country and/or governmental agency and/or regulatory requirement for an ID check of the user of the UE 302 prior to providing a cellular wireless service procedure, such as for downloading an eSIM 208 to the UE 302 for access to cellular wireless services of an MNO 114. At step 2, the MNO backend system 306 sends a confirm order message via an ES2+ interface to an SM-DP+ 308. The confirm order message is augmented to include MNO specific user data that is to be obtained from the UE 302 (and/or the user 304 thereof) and verified before an eSIM 208 reserved for the UE 302 can be provided to the UE 302. As indicated at step 1, the ES2+ confirm order message can include an extensible, customizable list of additional required user data, namely, for this particular exemplary embodiment, the required data includes performance of a live ID procedure for the UE 302 (and the user 304 thereof), referred by the label ‘Live ID Check’. Each user data point required by the MNO 114 can be specified in the ES2+ confirm order message by one or more fields, such as a descriptive label, a standardized type mask value, a data type value, an indication of whether hashing is required for the user data point, and optionally an error type mask. For the particular example illustrated in FIG. 7A, a type mask value of ‘199’ can be associated with a live ID check procedure. The confirm order message can further include a value for the live ID check procedure, e.g., inclusion of a specific resolvable network address, such as a universal record locator (URL) value that provides a link to a network reachable website at which the live ID check procedure can occur. The confirm order message can also include a session ID value for the live ID check procedure, where the session ID was previously established by the MNO backend system 306 with the live ID system 702 to be used for the live ID check procedure for the UE 302 (and the user 304 thereof).

At step 3, a user 304 of the UE 302 can initiate provisioning of an eSIM 208 to the UE 302. At step 4, the UE 302 performs a common mutual authentication procedure with the SM-DP+ 308. At step 5, the SM-DP+ 308 sends a message to the UE 302 indicating additional user data that is required for the requested eSIM download procedure to progress. The additional user data required can be specified using a list of required user data points, e.g., using the same format as specified in the ES2+ confirm order message received by the SM-DP+ 308 from the MNO backend system 306. In this exemplary embodiment, the additional user data required includes successful verification via a live ID check procedure. At step 6, the UE 302 can prompt the user 304 for consent to perform the live ID check procedure. At step 7, the UE 302 obtains from the user 304 consent for execution of the live ID check procedure. At step 8, the UE 302 establishes a live ID check session with the live ID system 702, e.g., using the URL value and session ID value provided in the message indicating additional required user data obtained at step 5 from the SM-DP+ 308. At step 9, optionally, the UE 302 can assist with information capture for the live ID check procedure, which can depend on requirements of the live ID system 702. In some embodiments, a camera, a microphone, or another audio and/or video input system of the UE 302 can be used to capture and provide information to the live ID system 702. At step 10, the live ID system 702 can use information obtained from the UE 302 to determine whether the UE 302 (and the user 304 thereof) satisfies requirements for a successful verification result from the live ID check procedure. In some embodiments, the live ID system 702 verifies an identity of the user 304 of the UE 302.

Continuing with flow diagram 710 of FIG. 7B, at step 11, the live ID system 702 provides a message indicating success or failure of verification of the user 304 of the UE 302, where the message includes the particular session ID value associated with the live ID check established by the live ID system 702 and provided to the MNO backend system 306 at step 1 for the UE 302. At step 12, the MNO backend system 306 provides to the SM-DP+ 308 a message indicating the success or failure of verification of the user 304 of the UE 302, where the message includes the particular session ID value associated with the live ID check for the UE 302. At step 13, the SM-DP+ provides to the MNO backend system 306 an acknowledgment receipt for the message indicating the live ID verification result. At step 14, the MNO backend system 306 provides to the live ID system an acknowledgment receipt for the message indicating the live ID verification result. At step 15, the MNO backend system provides to the SM-DP+ an additional acknowledgment message that can indicate to the SM-DP+ that the requested cellular wireless service procedure, e.g., eSIM 208 profile download to the UE 302, can proceed. In some embodiments, optionally, at step 16, the live ID system 702 and the UE 302 can execute a JavaScript callback procedure to indicate confirmation that the live ID check has been completed successfully and the user 304 of the UE 302 has been verified. Upon a successful verification by the live ID system 702 and verification success indication obtained, the SM-DP+ 308, at step 17, can initiate (or continue) performance of a standard eSIM 208 profile download procedure with the UE 302. At step 18, the UE 302 can optionally provide an indication to the MNO backend system 306 of a successful eSIM 208 download and installation on the eUICC 108 of the UE 302.

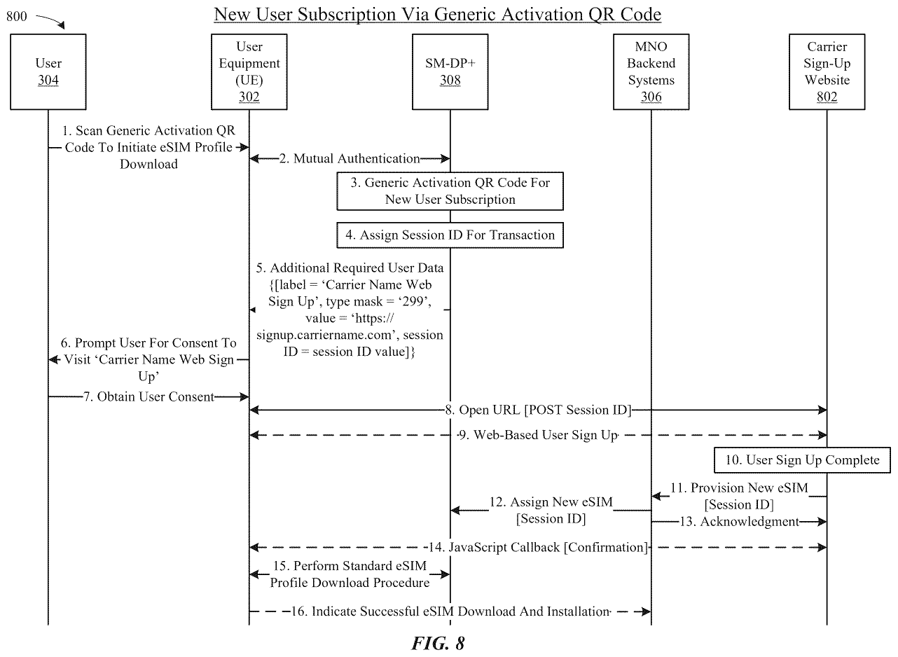

FIG. 8 illustrates a flow diagram 800 of an example of obtaining data for a new user subscription to a cellular wireless service for a user 304 of a UE 302 via scan of a generic activation QR code by the UE 302, which can redirect the UE 302 to a website to sign up for the cellular wireless service. An extensible, customizable user challenge message can be used to specify required user information for the new user subscription and obtain the user data in order to facilitate subscribing the user 304 to a cellular wireless service of an MNO 114. At step 1, a user 304 causes the UE 302 to scan a generic (not necessarily user-specific) QR code for obtaining an eSIM 208 associated with a cellular wireless service of an MNO 114. In some embodiments, the QR code is used for initiating an eSIM 208 profile download to wireless devices 102, such as to the UE 302. In some embodiments, the QR code includes information to assist the UE 302 to establish communication with an applicable network-reachable servers of an MNO 114 to establish a relationship with the MNO 114 in order to obtain cellular wireless service from the MNO 114, which can include obtaining an eSIM 208 to provide access to the cellular wireless service of the MNO 114. In some embodiments, the QR code includes information to allow the UE 302 to contact an MNO provisioning server 116, such as SM-DP+ 308. At step 2, the UE 302 performs a common mutual authentication procedure with the SM-DP+ 308. At step 3, the SM-DP+ 308 recognizes that the UE 302 has reached the SM-DP+ 308 as a result of scanning a generic activation QR code to establish a new user subscription with the MNO 114 associated with the SM-DP+ 308. At step 4, the SM-DP+ 308 assigns a session identifier (ID) value for the session between the UE 302 and the SM-DP+ 308. At step 5, the SM-DP+ sends a message to the UE 302 indicating additional user data that is required for the user subscription procedure and subsequent eSIM download procedure to progress. The additional user data required can be specified using a list of required user data points. Each user data point required by the MNO 114 can be specified by one or more fields, such as a descriptive label, a standardized type mask value, a data type value, an indication of whether hashing is required for the user data point, and optionally an error type mask. For the particular example illustrated in FIG. 8, the additional required user data message includes a descriptive label to identify the MNO 114 and the sign-up procedure, indicated as ‘Carrier Name Web Sign Up’, where the required user data to be provided by the user 304 of the UE 302 is for a user subscription sign-up procedure for the MNO 114 performed via a website of the MNO 114. The additional required user data message further includes a type mask value of ‘299’, which can be associated with an MNO 114 user subscription sign-up procedure. The additional required user data message can further include a value for the MNO sign-up procedure, e.g., inclusion of a specific resolvable network address, such as a universal record locator (URL) value that provides a link to a network reachable website at which the MNO sign-up procedure can occur. The confirm order message can also include a session ID value for the MNO sign-up procedure, where the session ID was assigned by the SM-DP+ at step 4. At step 6, the UE 302 can prompt the user 304 for consent to redirect the UE 302 to establish a connection with a user subscription sign-up website for the MNO 114 to complete an MNO sign-up procedure. At step 7, the UE 302 obtains from the user 304 consent to continue with the MNO sign-up procedure. At step 8, the UE 302 establishes a MNO sign-up procedure session with the carrier sign-up website 802, e.g., using the URL value and session ID value provided in the message indicating additional required user data obtained at step 5 from the SM-DP+ 308. At step 9, the user of the UE 302 performs the MNO sign-up procedure with the carrier sign-up website 802. In some embodiments, the UE 302 provides information and/or assistance to complete the MNO sign-up procedure. At step 10, the user 304 completes successfully the MNO sign-up procedure with the carrier sign-up website 802. At step 11, the carrier sign-up website 802 provides a message to the MNO backend system 306 to cause a new eSIM 208 to be provisioned for the UE 302, where the message can include the session ID value for the UE 302 (and the user 304 thereof) assigned previously by the SM-DP+ at step 4. In some embodiments, the session ID value provides a unique identifier for the UE 302 (and the user 304) for the new eSIM 208. At step 12, the MNO backend system 306 sends a message to the SM-DP+ 308 to cause the SM-DP+ 308 to assign an eSIM 308 to the UE 302 (which can be identified based at least in part on the session ID value included in the message and previously assigned by the SM-DP+ to the UE 302 for the MNO sign-up procedure). At step 13, the MNO backend system 306 provides an acknowledgment message to the carrier sign-up website 802 responsive to the message to provisioning the new eSIM 208 for the UE 302. In some embodiments, optionally, at step 14, the carrier sign-up website 802 and the UE 302 perform a JavaScript Callback procedure to confirm successful completion of the MNO sign-up procedure and permission to continue with an eSIM 208 download procedure to obtain the eSIM 208 for access to cellular wireless services of the MNO 114. At step 15, having successfully completed the MNO sign-up procedure, the UE 302 can perform a standard eSIM 208 profile download procedure with the SM-DP+ 308. At step 16, the UE 302 can optionally provide an indication to the MNO backend system 306 of a successful eSIM 208 download and installation on the eUICC 108 of the UE 302.

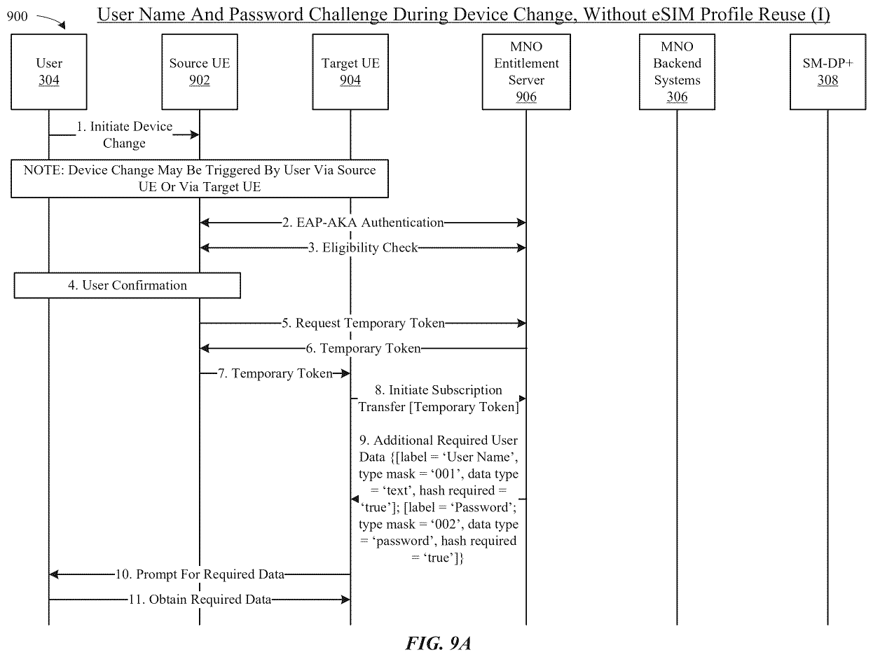

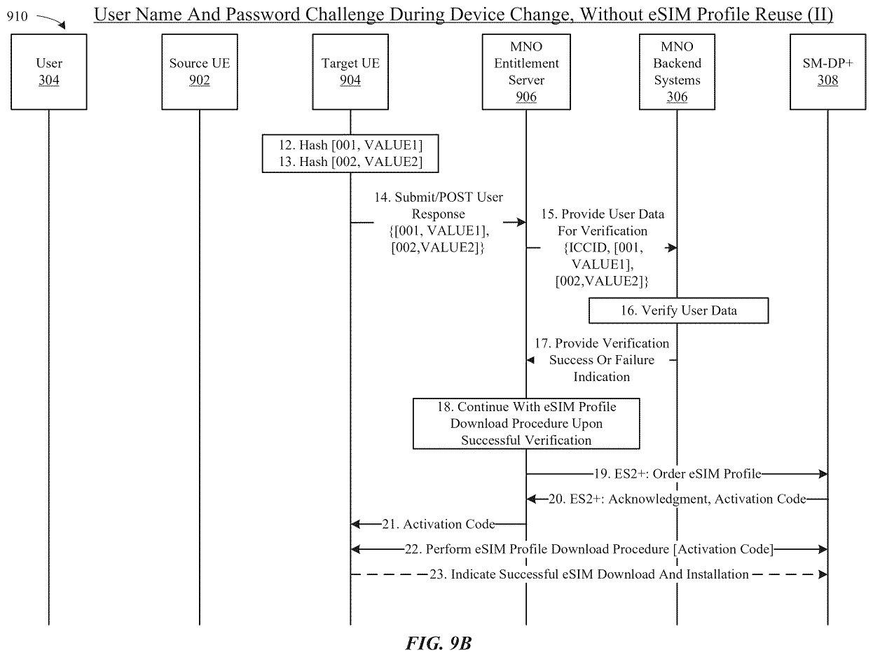

FIGS. 9A and 9B illustrate flow diagrams 900, 910 of an example of an extensible user challenge for user verification based on user name and password values for transfer of a cellular wireless service between wireless devices, e.g., between a source UE 902 and a target UE 904, without re-use of an existing eSIM 208 profile. An extensible, customizable user challenge message can be used to obtain the required user data in order to facilitate transfer of a cellular wireless service subscription of a user 304 from a source UE 902 to a target UE 904. In some embodiments, the extensible, customizable user challenge message can be used to obtain required user information to supplement a procedure for transfer of cellular wireless service between two wireless devices, i.e., additional to (and/or in conjunction with) a standardized TS.43 procedure. At step 1, the user 304 initiates the cellular wireless transfer procedure via the source UE 902. In some embodiments, the user 304 initiates the cellular wireless transfer procedure via the target UE 904. At step 2, the source UE 902 performs an EAP-AKA authentication procedure with an MNO entitlement server 906. In some embodiments, the MNO entitlement server 906 can be an SM-DS 310 as illustrated in FIG. 3. At step 3, the source UE 902 communicates with the MNO entitlement server 906 to check eligibility to transfer a cellular wireless service subscription from the source UE 902 to the target UE 904, e.g., compatibility of the target UE 904, permission to transfer based on the particular cellular wireless service subscription characteristics, etc. Upon successful verification of eligibility to transfer the cellular wireless service subscription, the source UE 902 can perform a user confirmation procedure with the user 304 to confirm intent of the user 304 to transfer the cellular wireless service subscription to the target UE 904. At step 5, the source UE 902 sends a request message to the MNO entitlement server 906 to obtain a temporary (e.g., one-time use, ephemeral, or the like) token associated with the device change from the source UE 902 to the target UE 904 and that can be used by the target UE 904 to indicate authorization to receive (and/or participate in) the cellular wireless service subscription transfer from the source UE 902. At step 6, the MNO entitlement server 906 provides the temporary token to the source UE 902. At step 7, the source UE 902 provides the temporary token to the target UE 904. At step 8, the target UE 904 sends a message to the MNO entitlement server 906 to initiate transfer of the cellular wireless subscription from the source UE 902 to the target UE 904, where the message includes the temporary token obtained from the source UE 902. At step 9, the MNO entitlement server 906 sends to the target UE 904 a message indicating additional user data that is required for the cellular wireless service subscription transfer procedure to be authorized to proceed. The additional user data required can be specified using a list of required user data points. Each user data point required by the MNO 114 can be specified by one or more fields, such as a descriptive label, a standardized type mask value, a data type value, an indication of whether hashing is required for the user data point, and optionally an error type mask. For the particular example illustrated in FIG. 9A, the additional required user data message includes two data points, a descriptive label to identify that a user identifier (ID), referred to by the label ‘User Name” is a required first data point, and an associated password of the user 304, indicated by the label ‘Password’, is a required second data point. The additional required user data message further includes a type mask value of ‘001’ associated with a user name for the first data point and a type mask value of ‘002’ associated with a password for the second data point. The additional required user data message also includes data type specifications for the two data points, namely a ‘text’ data type for the ‘User Name’ data point and a ‘password’ data type for the ‘Password’ data point. The additional required user data message further includes an indication that each of the obtained data points should have a hashing algorithm applied prior to transfer of the hashed user data point values for verification. At step 10, the target UE 904 can prompt the user 304 for the required data, e.g., via a locally customized user interface that presents the request for the required data in a user-friendly format. At step 11, the target UE 904 obtains values for the required data points from the user 304, e.g., a user name value and a password value.

Continuing with flow diagram 910 of FIG. 9B, at step 12, as specified by the MNO entitlement server 906 at step 9, the target UE 904 can be required to apply a hashing algorithm to the two required user data point values. At steps 12 and 13, the target UE 904 can apply the hashing algorithm to each of the user name value and the password value to create a hashed user name value (indicated as VALUE1) and a hashed password value (indicated as VALUE2). At step 14, the target UE 904 can provide a user response to the MNO entitlement server 906 with the hashed versions of the required user data point values. In some embodiments, the hashed versions of the user data points are communicated in an ordered list, with each user data point specified by a type mask value and an associated user data point value (which can be a hashed version of the user supplied data point value). At step 15, the MNO entitlement server 906 provides the user data to the MNO backend system 306 for verification. In some embodiments, the user data points are communicated in an ordered list, which can include an integrated circuit card identifier (ICCID) value for the eSIM 208 that is associated with transfer of cellular wireless service from the source UE 902 to the target UE 904 (and/or with a cellular wireless service subscription account of the user 304 of the source UE 902 and the target UE 904) along with each user data point specified by a type mask value and an associated user data point value (which can be a hashed version of the user supplied data point value). At step 16, the MNO backend system 306 can compare the provided user data with existing user data values known to the MNO backend system 306 to verify validity of the user data and determine (at least part) that the target UE 904 and/or the user 304 is authorized for the requested cellular wireless service procedure, e.g., transfer of the cellular wireless service subscription from the source UE 902 to the target UE 904. At step 17, the MNO backend system 306 provides an indication of verification success or failure to the MNO entitlement server 906. At step 18, the MNO entitlement server 906 can determine whether to continue with the cellular wireless service transfer and initiate provisioning of an eSIM 208 profile to the target UE 904. At step 19, upon successful verification, the MNO entitlement server 906 sends a message via an ES2+ interface to the SM-DP+ 308 to allocate an eSIM 208 profile for the target UE 904. At step 20, the SM-DP+ 308 provides an acknowledgment message via the ES2+ interface to the MNO entitlement server 906, where the acknowledgment message includes an activation code that the target UE 904 can use to perform an eSIM 208 profile download procedure with the SM-DP+ 308. The MNO entitlement server 906, at step 21, provides the activation code to the target UE 904. At step 22, the target UE 904 establishes a connection with and performs an eSIM 208 profile download procedure with the SM-DP+ 308 to obtain an eSIM 208 profile associated with the transfer of cellular wireless service from the source UE 902 to the target UE 904. The target UE 904 can provide the activation code to the SM-DP+ 308 to verify the authority to obtain the eSIM 208 profile. At step 23, the target UE 904 can optionally provide an indication to the MNO backend system 306 of a successful eSIM 208 download and installation on the eUICC 108 of the target UE 904.

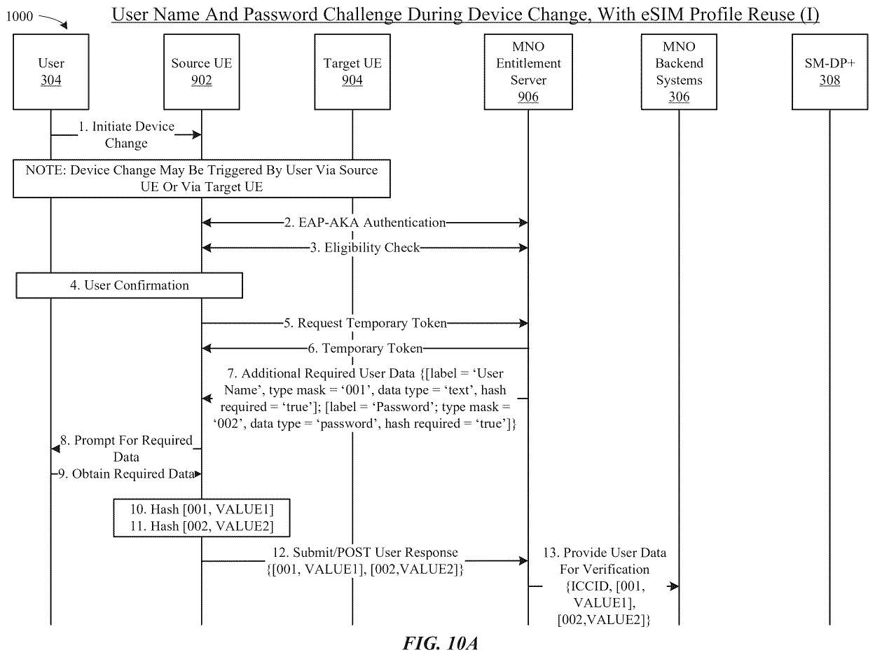

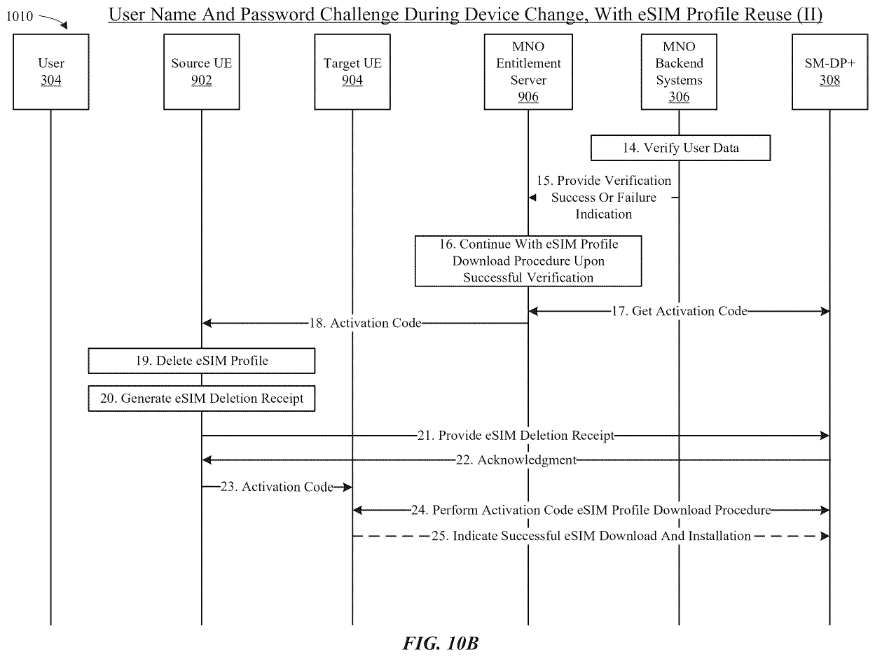

FIGS. 10A and 10B illustrate flow diagrams 1000, 1010 of an example of an extensible user challenge for user verification based on user name and password values for transfer of a cellular wireless service between wireless devices, e.g., between a source UE 902 and a target UE 904, with re-use of an existing eSIM 208 profile. An extensible, customizable user challenge message can be used to obtain the required user data in order to facilitate transfer of a cellular wireless service subscription of a user 304 from a source UE 902 to a target UE 904. In some embodiments, the extensible, customizable user challenge message can be used to obtain required user information to supplement a procedure for transfer of cellular wireless service between two wireless devices, i.e., additional to (and/or in conjunction with) a standardized TS.43 procedure. At step 1, the user 304 initiates the cellular wireless transfer procedure via the source UE 902. In some embodiments, the user 304 initiates the cellular wireless transfer procedure via the target UE 904. At step 2, the source UE 902 performs an EAP-AKA authentication procedure with an MNO entitlement server 906. In some embodiments, the MNO entitlement server 906 can be an SM-DS 310 as illustrated in FIG. 3. At step 3, the source UE 902 communicates with the MNO entitlement server 906 to check eligibility to transfer a cellular wireless service subscription from the source UE 902 to the target UE 904, e.g., compatibility of the target UE 904, permission to transfer based on the particular cellular wireless service subscription characteristics, etc. Upon successful verification of eligibility to transfer the cellular wireless service subscription, the source UE 902 can perform a user confirmation procedure with the user 304 to confirm intent of the user 304 to transfer the cellular wireless service subscription to the target UE 904. At step 5, the source UE 902 sends a request message to the MNO entitlement server 906 to obtain a temporary (e.g., one-time use, ephemeral, or the like) token associated with the device change from the source UE 902 to the target UE 904. At step 6, the MNO entitlement server 906 provides the temporary token to the source UE 902. At step 7, the MNO entitlement server 906 sends to the source UE 902 a message indicating additional user data that is required for the cellular wireless service subscription transfer procedure to be authorized to proceed. The additional user data required can be specified using a list of required user data points. Each user data point required by the MNO 114 can be specified by one or more fields, such as a descriptive label, a standardized type mask value, a data type value, an indication of whether hashing is required for the user data point, and optionally an error type mask. For the particular example illustrated in FIG. 10A, the additional required user data message includes two data points, a descriptive label to identify that a user identifier (ID), referred to by the label ‘User Name” is a required first data point, and an associated password of the user 304, indicated by the label ‘Password’, is a required second data point. The additional required user data message further includes a type mask value of ‘001’ associated with a user name for the first data point and a type mask value of ‘002’ associated with a password for the second data point. The additional required user data message also includes data type specifications for the two data points, namely a ‘text’ data type for the ‘User Name’ data point and a ‘password’ data type for the ‘Password’ data point. The additional required user data message further includes an indication that each of the obtained data points should have a hashing algorithm applied prior to transfer of the hashed user data point values for verification. At step 8, the source UE 902 can prompt the user 304 for the required data, e.g., via a locally customized user interface that presents the request for the required data in a user-friendly format. At step 9, the source UE 902 obtains values for the required data points from the user 304, e.g., a user name value and a password value. At step 10, as specified by the MNO entitlement server 906 at step 7, the source UE 902 can be required to apply a hashing algorithm to the two required user data point values. At steps 10 and 11, the source UE 902 can apply the hashing algorithm to each of the user name value and the password value to create a hashed user name value (indicated as VALUE1) and a hashed password value (indicated as VALUE2). At step 12, the source UE 902 can provide a user response to the MNO entitlement server 906 with the hashed versions of the required user data point values. In some embodiments, the hashed versions of the user data points are communicated in an ordered list, with each user data point specified by a type mask value and an associated user data point value (which can be a hashed version of the user supplied data point value). At step 13, the MNO entitlement server 906 provides the user data to the MNO backend system 306 for verification. In some embodiments, the user data points are communicated in an ordered list, which can include an integrated circuit card identifier (ICCID) value for the eSIM 208 that is associated with transfer of cellular wireless service from the source UE 902 to the target UE 904 (and/or with a cellular wireless service subscription account of the user 304 of the source UE 902 and the target UE 904) along with each user data point specified by a type mask value and an associated user data point value (which can be a hashed version of the user supplied data point value).

Continuing with flow diagram 1010 of FIG. 10B, at step 14, the MNO backend system 306 can compare the provided user data with existing user data values known to the MNO backend system 306 to verify validity of the user data and determine (at least part) that the target UE 904 and/or the user 304 is authorized for the requested cellular wireless service procedure, e.g., transfer of the cellular wireless service subscription from the source UE 902 to the target UE 904. At step 15, the MNO backend system 306 provides an indication of verification success or failure to the MNO entitlement server 906. At step 16, the MNO entitlement server 906 can determine whether to continue with the cellular wireless service transfer and initiate provisioning of an eSIM 208 profile to the target UE 904. At step 17, upon successful verification, the MNO entitlement server 906 interacts with the SM-DP+ 308 via an ES2+ interface to the SM-DP+ 308 to obtain an activation code for the target UE 904 to use to obtain an eSIM 208 associated with transfer of the cellular wireless service from the source UE 902 to the target UE 904. At step 18, the MNO entitlement server 906 provides the activation code to the source UE 902. At step 19, the source UE 902 deletes an eSIM 208 profile associated with the cellular wireless service to be transferred to the target UE 904. At step 20, source UE 902 generates an eSIM 208 deletion receipt. At step 21, the source UE 902 provides the eSIM 208 deletion receipt to the SM-DP+ 308, which the SM-DP+ 308 acknowledges to the source UE 902 at step 22. After deletion of the eSIM 208 profile from the source UE 902 and receipt of the acknowledgment from the SM-DP+ 208, the source UE 902 provides the activation code to the target UE 904 to allow the target UE 904 to download and re-use the deleted eSIM 208 profile. At step 24, the target UE 904 establishes a connection to the SM-DP+ 308 and provides the activation code to the SM-DP+ 308 as part of an eSIM 208 profile download and installation procedure, the activation code providing an indication of authorization by the target UE 904 to obtain the eSIM 208 profile. At step 25, the target UE 904 can optionally provide an indication to the MNO backend system 306 of a successful eSIM 208 download and installation on the eUICC 108 of the target UE 904.

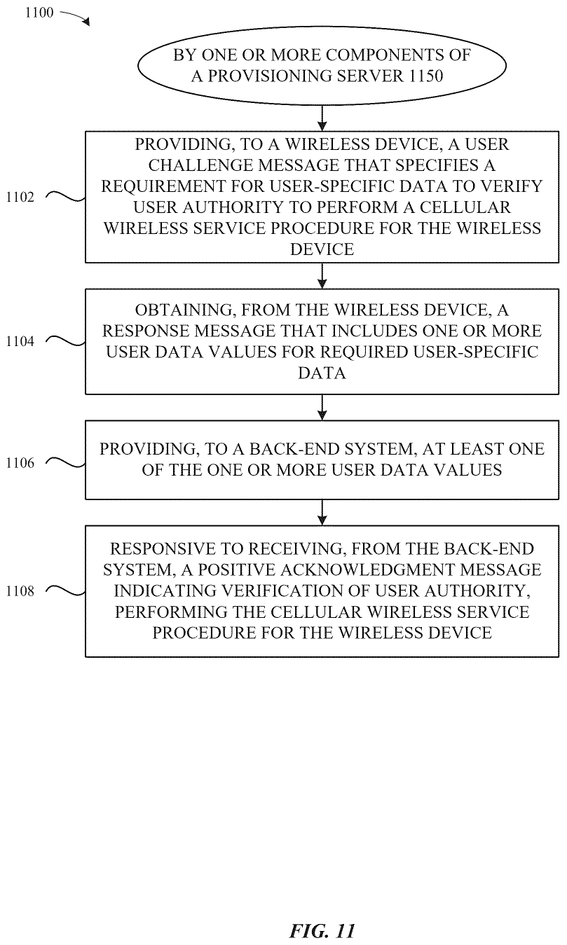

FIG. 11 illustrates a flowchart 1100 of a representative method to provide an extensible user challenge to verify user authority to perform a cellular wireless service procedure for a wireless device 102, e.g. UE 302, source UE 902, and/or target UE 904. At block 1102, one or more components of a provisioning server 1150, e.g., provisioning server 116 and/or SM-DP+ 308, provide, to a wireless device 102, a user challenge message that specifies a requirement for user-specific data to verify user authority to perform the cellular wireless service procedure for the wireless device 102. At block 1104, the one or more components of the provisioning server 1150 obtain, from the wireless device 102, a response message that includes one or more user data values for required user-specific data. At block 1106, the one or more components of the provisioning server, provide to a backend system, e.g., MNO backend system 306, at least one of the one or more user data values. At block 1108, the one or more components of the provisioning server 1150, responsive to receiving, from the backend system, a positive acknowledgement message indicating verification of user authority, performing the cellular wireless service procedure for the wireless device 102.

In some embodiments, the cellular wireless service procedure includes an eSIM 208 profile download to the wireless device 102. In some embodiments, the cellular wireless service procedure includes transfer of a cellular wireless service associated with an eSIM 208 profile of the wireless device 102 to another wireless device 102, e.g., from a source UE 902 to a target UE 904, where the wireless device is the source UE 902. In some embodiments, the cellular wireless service procedure includes transfer of a cellular wireless service associated with an eSIM 208 profile of another wireless device 102 to the wireless device 102, e.g., from a source UE 902 to a target UE 904, where the wireless device 102 is the target UE 904. In some embodiments, the method further includes the one or more components of the provisioning server 1150 receiving, from the backend system via an ES2+ interface, a confirm order message that specifies the requirement for the user-specific data to verify user authority to perform the cellular wireless service procedure for the wireless device 102. In some embodiments, the confirm order message includes a standardized type mask value for each of the required user-specific data. In some embodiments, the confirm order message includes an indication of whether hashing is required to be applied by the wireless device 102 to each of the required user-specific data. In some embodiments, the confirm order message includes an MNO 114 specified label for each of the required user-specific data. In some embodiments, the required user-specific data includes a user name and password for a cellular wireless service account. In some embodiments, the method further includes the one or more components of the provisioning server 1150: i) responsive to receipt, from the backend system, of an error message indicating a verification failure for the user authority to perform the cellular wireless service procedure for the wireless device 102, providing to the wireless device 102 a corresponding error message indicating at least one error in the one or more user data values for the required user-specific data; ii) obtaining, from the wireless device 102, a second response message that includes one or more additional user data values for the required user-specific data, iii) providing, to the backend system, at least one of the one or more additional user data values; and iv) responsive to receipt, from the backend system, of the positive acknowledgment message indicating verification of user authority, performing the cellular wireless service procedure for the wireless device 102. In some embodiments, the error message received from the backend system includes a standardized type mask value for each of the at least one error in the required user-specific data; and the corresponding error message provided to the wireless device 102 includes the standardized type mask value for each of the at least one error in the required user-specific data. In some embodiments, the one or more additional user data values for the required user-specific data includes a data value for each standardized type mask value included in the corresponding error message. In some embodiments, the one or more additional user data values for the required user-specific data includes at least one supplemental or repeated data value that was not indicated to be in error. In some embodiments, the one or more user data values includes a text corresponding to a scan of a QR code by the wireless device 102 for subscription to a cellular wireless service.

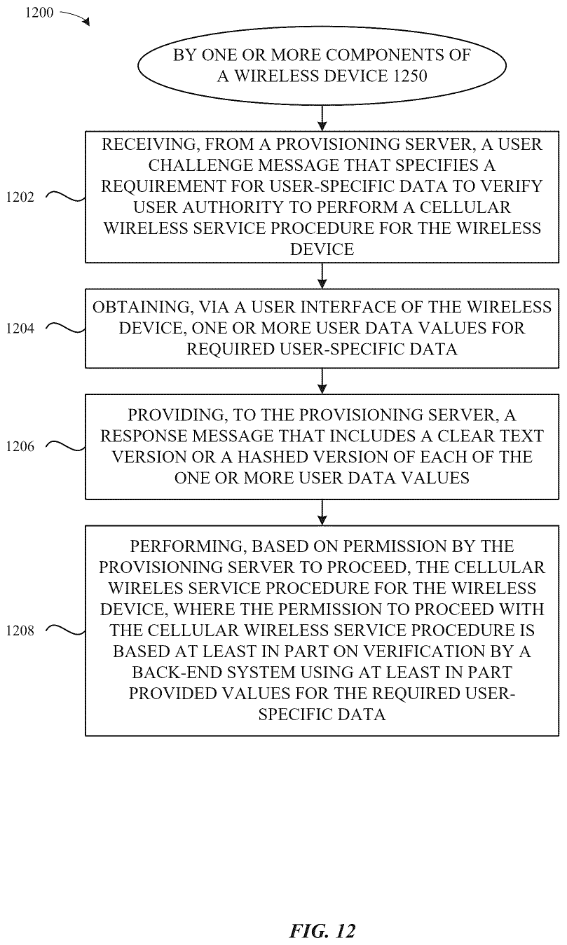

FIG. 12 illustrates a flowchart 1200 of another exemplary method to provide an extensible user challenge to verify user authority to perform a cellular wireless service procedure for a wireless device 1250, e.g. UE 302, source UE 902, and/or target UE 904. At block 1202, one or more components of a wireless device 1250, receive, from a provisioning server 1150, e.g., provisioning server 116 and/or SM-DP+ 308, a user challenge message that specifies a requirement for user-specific data to verify user authority to perform the cellular wireless service procedure for the wireless device 1250. At block 1204, the one or more components of the wireless device 1250, obtain one or more user data values for required user-specific data, where the one or more user data values are obtained from a user interface. At block 1206, the one or more components of the wireless device 1250, provide, to the provisioning server 1150, a response message that includes a clear text version or a hashed version of each of the one or more user data values. At block 1208, the one or more components of the wireless device 1250 perform, based on permission by the provisioning server 1150 to proceed, the cellular wireless service procedure for the wireless device 1250, where the permission to proceed with the cellular wireless service procedure is based at least in part on verification by a backend system, e.g., MNO backend system 306, using at least in part provided values for the required user-specific data.

In some embodiments, the cellular wireless service procedure includes an eSIM 208 profile download to the wireless device 1250. In some embodiments, the cellular wireless service procedure includes transfer of a cellular wireless service associated with an eSIM 208 profile of the wireless device 1250 to another wireless device 102, e.g., wherein the wireless device 1250 is a source UE 902 and the another wireless device 102 is a target UE 904. In some embodiments, the cellular wireless service procedure includes transfer of a cellular wireless service associated with an eSIM 208 profile of another wireless device to the wireless device 1250, where the another wireless device is a source UE 902 and the wireless device is a target UE 904. In some embodiments, the required user-specific data includes a user name and password for a cellular wireless service account. In some embodiments, the method further includes the one or more components of the wireless device 1250: i) receiving, from the provisioning server 1150, an error message indicating at least one error in provided user data values for the required user-specific data; and ii) providing, to the provisioning server 1150, a second response message that includes one or more additional user data values for the required user-specific data, where the permission to proceed with the cellular wireless procedure is based at least in part on correction of the at least one error using the one or more additional user data values. In some embodiments, the error message received from the provisioning server 1150 includes the standardized type mask value for each of the at least one error in the required user-specific data. In some embodiments, the one or more additional user data values for the required user-specific data includes a data value for each standardized type mask value included in the corresponding error message. In some embodiments, the one or more additional user data values for the required user-specific data comprises at least one supplemental or repeated data value that was not indicated to be in error. In some embodiments, the one or more user data values includes a text corresponding to a scan of a QR code by the wireless device 1250 for subscription to a cellular wireless service.

### Representative Exemplary Apparatus

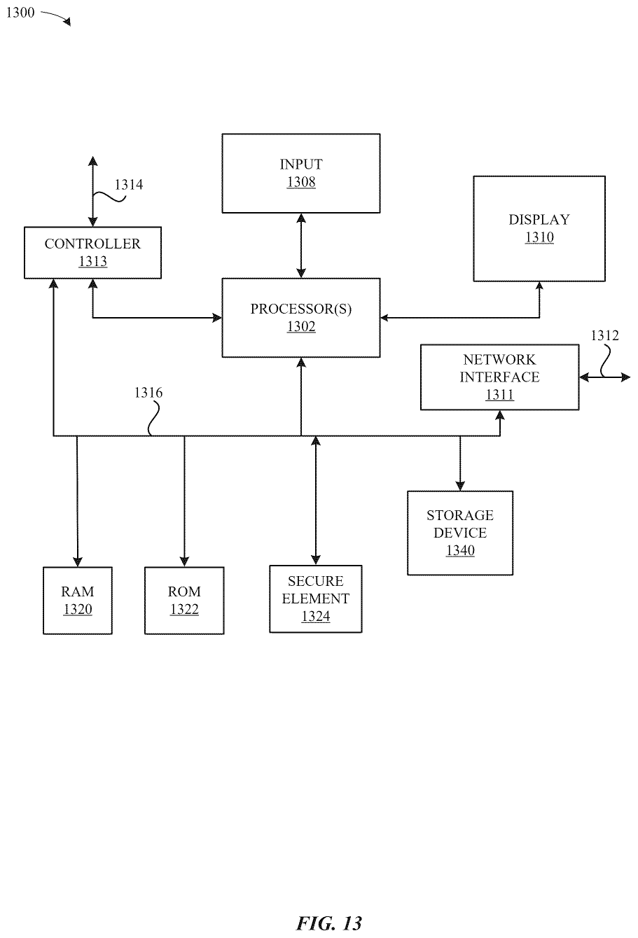

FIG. 13 illustrates in block diagram format an exemplary computing device 1300 that can be used to implement the various components and techniques described herein, according to some embodiments. In particular, the detailed view of the exemplary computing device 1300 illustrates various components that can be included in a UE 302 or a wireless device 102. As shown in FIG. 13, the computing device 1300 can include one or more processors 1302 that represent microprocessors or controllers for controlling the overall operation of computing device 1300. In some embodiments, the computing device 1300 can also include a user input device 1308 that allows a user of the computing device 1300 to interact with the computing device 1300. For example, in some embodiments, the user input device 1308 can take a variety of forms, such as a button, keypad, dial, touch screen, audio input interface, visual/image capture input interface, input in the form of sensor data, etc. In some embodiments, the computing device 1300 can include a display 1310 (screen display) that can be controlled by the processor(s) 1302 to display information to the user (for example, information relating to incoming, outgoing, or active communication sessions). A data bus 1316 can facilitate data transfer between at least a storage device 1340, the processor(s) 1302, and a controller 1313. The controller 1313 can be used to interface with and control different equipment through an equipment control bus 1314. The computing device 1300 can also include a network/bus interface 1311 that couples to a data link 1312. In the case of a wireless connection, the network/bus interface 1311 can include wireless circuitry, such as a wireless transceiver and/or baseband component. The computing device 1300 can also include a secure element 1324, which can be configured to store one or more SIM profiles and/or eSIM 208 profiles. The secure element 1324 can include an eUICC 108, an iUICC, and/or one or more UICCs 118.

The computing device 1300 also includes a storage device 1340, which can include a single storage or a plurality of storages (e.g., hard drives and/or solid-state drives), and includes a storage management module that manages one or more partitions within the storage device 1340. In some embodiments, storage device 1340 can include flash memory, semiconductor (solid state) memory or the like. The computing device 1300 can also include a Random-Access Memory (RAM) 1320 and a Read-Only Memory (ROM) 1322. The ROM 1322 can store programs, utilities or processes to be executed in a non-volatile manner. The RAM 1320 can provide volatile data storage, and stores instructions related to the operation of the computing device 1300.

### Wireless Terminology

In accordance with various embodiments described herein, the terms “wireless communication device,” “wireless device,” “mobile device,” “mobile station,” “mobile wireless device,” and “user equipment” (UE) may be used interchangeably herein to describe one or more consumer electronic devices that may be capable of performing procedures associated with various embodiments of the disclosure. In accordance with various implementations, any one of these consumer electronic devices may relate to: a cellular phone or a smart phone, a tablet computer, a laptop computer, a notebook computer, a personal computer, a netbook computer, a media player device, an electronic book device, a MiFi® device, a wearable computing device, as well as any other type of electronic computing device having wireless communication capability that can include communication via one or more wireless communication protocols such as used for communication on: a wireless wide area network (WWAN), a wireless metro area network (WMAN) a wireless local area network (WLAN), a wireless personal area network (WPAN), a near-field communication (NFC), a cellular wireless network, a fourth generation (4G) LTE, LTE Advanced (LTE-A), 5G, and/or 6G or other present or future developed advanced cellular wireless networks.

The wireless device, in some embodiments, can also operate as part of a wireless communication system, which can include a set of client devices, which can also be referred to as stations, client wireless devices, or client wireless communication devices, interconnected to an access point (AP), e.g., as part of a WLAN, and/or to each other, e.g., as part of a WPAN and/or an “ad hoc” wireless network. In some embodiments, the client device can be any wireless device that is capable of communicating via a WLAN technology, e.g., in accordance with a wireless local area network communication protocol. In some embodiments, the WLAN technology can include a Wi-Fi (or more generically a WLAN) wireless communication subsystem or radio, the Wi-Fi radio can implement an Institute of Electrical and Electronics Engineers (IEEE) 802.11 technology, such as one or more of: IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies.

Additionally, it should be understood that the UEs described herein may be configured as multi-mode wireless devices that are also capable of communicating via different radio access technologies (RATs). In these scenarios, a multi-mode user equipment (UE) can be configured to prefer attachment to a 5G wireless network offering faster data rate throughput, as compared to other 4G LTE legacy networks offering lower data rate throughputs. For instance, in some implementations, a multi-mode UE may be configured to fall back to a 4G LTE network or a 3G legacy network, e.g., an Evolved High Speed Packet Access (HSPA+) network or a Code Division Multiple Access (CDMA) 2000 Evolution-Data Only (EV-DO) network, when 5G wireless networks are otherwise unavailable.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a non-transitory computer readable medium. The non-transitory computer readable medium is any data storage device that can store data which can thereafter be read by a computer system. Examples of the non-transitory computer readable medium include read-only memory, random-access memory, CD-ROMs, HDDs, DVDs, magnetic tape, and optical data storage devices. The non-transitory computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A method to provide an extensible user challenge to verify user authority to perform a cellular wireless service procedure for a wireless device, the method comprising:
by one or more components of a provisioning server:
providing, to the wireless device, a user challenge message that specifies a requirement for user-specific data to verify user authority to perform the cellular wireless service procedure for the wireless device;
obtaining, from the wireless device, a response message that includes one or more user data values for required user-specific data;
providing, to a backend system, at least one of the one or more user data values; and
responsive to receiving, from the backend system, a positive acknowledgment message indicating verification of user authority, performing the cellular wireless service procedure for the wireless device.

2. The method of claim 1, wherein the cellular wireless service procedure comprises:
an electronic subscriber identity module (eSIM) profile download to the wireless device,
transfer of a cellular wireless service associated with an eSIM profile of the wireless device to another wireless device, or
transfer of a cellular wireless service associated with an eSIM profile of another wireless device to the wireless device.

3. The method of claim 1, further comprising:
receiving, from the backend system via an ES2+ interface, a confirm order message that specifies the requirement for the user-specific data to verify the user authority to perform the cellular wireless service procedure for the wireless device.

4. The method of claim 3, wherein the confirm order message comprises one or more of:
a standardized type mask value for each of the required user-specific data,
an indication of whether hashing is required to be applied by the wireless device to each of the required user-specific data, or
a mobile network operator (MNO) specified label for each of the required user-specific data.

5. The method of claim 1, wherein the required user-specific data comprises a user name and password for a cellular wireless service account.

6. The method of claim 1, further comprising:
responsive to receipt, from the backend system, of an error message indicating a verification failure for the user authority to perform the cellular wireless service procedure for the wireless device, providing to the wireless device a corresponding error message indicating at least one error in the one or more user data values for the required user-specific data;
obtaining, from the wireless device, a second response message that comprises one or more additional user data values for the required user-specific data;
providing, to the backend system, at least one of the one or more additional user data values; and
responsive to receipt, from the backend system, of the positive acknowledgment message indicating verification of user authority, performing the cellular wireless service procedure for the wireless device.

7. The method of claim 6, wherein:
the error message received from the backend system comprises a standardized type mask value for each of the at least one error in the required user-specific data; and
the corresponding error message provided to the wireless device comprises the standardized type mask value for each of the at least one error in required the user-specific data.

8. The method of claim 7, wherein:
the one or more additional user data values for the required user-specific data comprises:
a data value for each standardized type mask value included in the corresponding error message, and/or
at least one supplemental or repeated data value that was not indicated to be in error.

9. The method of claim 1, wherein:
the one or more user data values comprises a text corresponding to a scan of a quick response (QR) code by the wireless device for subscription to a cellular wireless service.

10. A method to provide an extensible user challenge to verify user authority to perform a cellular wireless service procedure for a wireless device, the method comprising:
by one or more components of the wireless device:
receiving, from a provisioning server, a user challenge message that specifies a requirement for user-specific data to verify user authority to perform the cellular wireless service procedure for the wireless device; and
obtaining one or more user data values for required user-specific data, wherein the one or more user data values are obtained from a user interface;
providing, to the provisioning server, a response message that includes a clear text version or a hashed version of each of the one or more user data values; and
performing, based on permission by the provisioning server to proceed, the cellular wireless service procedure for the wireless device,
wherein the permission to proceed with the cellular wireless service procedure is based at least in part on verification by a backend system using at least in part values provided in the response message for the required user-specific data.

11. The method of claim 10, wherein the cellular wireless service procedure comprises an electronic subscriber identity module (eSIM) profile download to the wireless device.

12. The method of claim 10, wherein the cellular wireless service procedure comprises transfer of a cellular wireless service associated with an eSIM profile of the wireless device to another wireless device.

13. The method of claim 10, wherein the cellular wireless service procedure comprises transfer of a cellular wireless service associated with an eSIM profile of another wireless device to the wireless device.

14. The method of claim 10, wherein the required user-specific data comprises a user name and password for a cellular wireless service account.

15. The method of claim 10, further comprising:
receiving, from the provisioning server, an error message indicating at least one error in values provided for the required user-specific data; and
providing, to the provisioning server, a second response message that comprises a clear text version or a hashed version of each of one or more additional user data values for the required user-specific data,
wherein the permission to proceed with the cellular wireless service procedure is based at least in part on correction of the at least one error using the one or more additional user data values.

16. The method of claim 15, wherein:
the error message received from the provisioning server comprises a standardized type mask value for each of the at least one error in the values provided for the required user-specific data.

17. The method of claim 16, wherein:
the one or more additional user data values for the required user-specific data comprises a data value for each standardized type mask value included in the error message.

18. The method of claim 17, wherein:
the one or more additional user data values for the required user-specific data comprises at least one supplemental or repeated data value that was not indicated to be in error.

19. The method of claim 10, wherein:
the one or more user data values comprises a text corresponding to a scan of a quick response (QR) code by the wireless device for subscription to a cellular wireless service.

20. An apparatus comprising one or more processors coupled to a memory storing instructions to provide an extensible user challenge to verify user authority to perform a cellular wireless service procedure, the one or more processors configured to:
receive, from a provisioning server, a user challenge message that specifies a requirement for user-specific data to verify user authority to perform the cellular wireless service procedure; and
obtain one or more user data values for required user-specific data, wherein the one or more user data values are obtained from a user interface;
provide, to the provisioning server, a response message that includes a clear text version or a hashed version of each of the one or more user data values; and
perform, based on permission by the provisioning server to proceed, the cellular wireless service procedure,
wherein the permission to proceed with the cellular wireless service procedure is based at least in part on verification by a backend system using at least in part values provided in the response message for the required user-specific data.
